(19) United States
(12) Patent Application Publication
(10) Pub. No.: US 2017/0011258 A1
(43) Pub. Date: Jan. 12, 2017

(54) IMAGE ANALYSIS IN SUPPORT OF ROBOTIC MANIPULATION

(71) Applicant: Affectiva, Inc., Waltham, MA (US)

(72) Inventors: Boisy G. Pitre, Opelousas, LA (US); Rana el Kaliouby, Milton, MA (US); Abdelrahman Mahmoud, Somerville, MA (US); Seyedmohammad Mavadati, Watertown, MA (US); Daniel McDuff, Cambridge, MA (US); Panu James Turcot, San Francisco, CA (US); Gabriele Zijderveld, Somerville, MA (US)

(21) Appl. No.: 15/273,765

(22) Filed: Sep. 23, 2016

Related U.S. Application Data
(63) Continuation-in-part of application No. 14/796,419, filed on Jul. 10, 2015.
Application No. 14/796,419 is a continuation-in-part of application No. 13/153,745, filed on Jun. 6, 2011.
Application No. 14/796,419 is a continuation-in-part of application No. 14/460,915, filed on Aug. 15, 2014.
Application No. 14/796,419 is a continuation-in-part of application No. 13/153,745, filed on Jun. 6, 2011.
(60) Provisional application No. 62/222,518, filed on Sep. 23, 2015.
(60) Provisional application No. 62/265,937, filed on Dec. 10, 2015.
(60) Provisional application No. 62/273,896, filed on Dec. 31, 2015.
(60) Provisional application No. 62/301,558, filed on Feb. 29, 2016.
(60) Provisional application No. 62/370,421, filed on Aug. 3, 2016.
(60) Provisional application No. 62/023,800, filed on Jul. 11, 2014.
(60) Provisional application No. 62/047,508, filed on Sep. 8, 2014.
(60) Provisional application No. 62/082,579, filed on Nov. 20, 2014.
(60) Provisional application No. 62/128,974, filed on Mar. 5, 2015.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.
(60) Provisional application No. 61/867,007, filed on Aug. 16, 2013.
(60) Provisional application No. 61/924,252, filed on Jan. 7, 2014.
(60) Provisional application No. 61/916,190, filed on Dec. 14, 2013.
(60) Provisional application No. 61/927,481, filed on Jan. 15, 2014.
(60) Provisional application No. 61/953,878, filed on Mar. 16, 2014.
(60) Provisional application No. 61/972,314, filed on Mar. 30, 2014.
(60) Provisional application No. 62/023,800, filed on Jul. 11, 2014.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.

(51) Int. Cl. G06K 9/00; B25J 9/00; B25J 13/00; G10L 25/63; B25J 13/08

(52) U.S. Cl. CPC G06K 9/00302; G06K 9/00241; G06K 9/00275; G10L 25/63; B25J 13/087; B25J 13/003; B25J 9/0003; Y10S 901/09

(57) ABSTRACT

Facial expressions are evaluated for control of robots. One or more images of a face are captured. The images are analyzed for mental state data. The images are analyzed to determine a facial expression of the face within an identified a region of interest. Mental state information is generated. A context for the robot operation is determined. A context for the individual is determined. The actions of a robot are then controlled based on the facial expressions and the mental state information that was generated. Displays, color, sound, motion, and voice response for the robot are controlled based on the facial expressions of one or more people.

### RELATED APPLICATIONS

This application claims the benefit of U.S. provisional patent applications “Image Analysis In Support of Robotic Manipulation” Ser. No. 62/222,518, filed Sep. 23, 2015, “Analysis of Image Content with Associated Manipulation of Expression Presentation” Ser. No. 62/265,937, filed Dec. 12, 2015, “Image Analysis Using Sub-Sectional Component Evaluation To Augment Classifier Usage” Ser. No. 62/273,896, filed Dec. 31, 2015, “Analytics for Live Streaming Based on Image Analysis within a Shared Digital Environment” Ser. No. 62/301,558, filed Feb. 29, 2016, and “Deep Convolutional Neural Network Analysis of Images for Mental States” Ser. No. 62/370,421, filed Aug. 3, 2016.

This application is also a continuation-in-part of U.S. patent application “Mental State Event Definition Generation” Ser. No. 14/796,419, filed Jul. 10, 2015 which claims the benefit of U.S. provisional patent applications “Mental State Event Definition Generation” Ser. No. 62/023,800, filed Jul. 11, 2014, “Facial Tracking with Classifiers” Ser. No. 62/047,508, filed Sep. 8, 2014, “Semiconductor Based Mental State Analysis” Ser. No. 62/082,579, filed Nov. 20, 2014, and “Viewership Analysis Based On Facial Evaluation” Ser. No. 62/128,974, filed Mar. 5, 2015. The patent application “Mental State Event Definition Generation” Ser. No. 14/796,419, filed Jul. 10, 2015 is also a continuation-in-part of U.S. patent application “Mental State Analysis Using Web Services” Ser. No. 13/153,745, filed Jun. 6, 2011, which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011. The patent application “Mental State Event Definition Generation” Ser. No. 14/796,419, filed Jul. 10, 2015 is also a continuation-in-part of U.S. patent application “Mental State Analysis Using an Application Programming Interface” Ser. No. 14/460,915, Aug. 15, 2014, which claims the benefit of U.S. provisional patent applications “Application Programming Interface for Mental State Analysis” Ser. No. 61/867,007, filed Aug. 16, 2013, “Mental State Analysis Using an Application Programming Interface” Ser. No. 61/924,252, filed Jan. 7, 2014, “Heart Rate Variability Evaluation for Mental State Analysis” Ser. No. 61/916,190, filed Dec. 14, 2013, “Mental State Analysis for Norm Generation” Ser. No. 61/927,481, filed Jan. 15, 2014, “Expression Analysis in Response to Mental State Express Request” Ser. No. 61/953,878, filed Mar. 16, 2014, “Background Analysis of Mental State Expressions” Ser. No. 61/972,314, filed Mar. 30, 2014, and “Mental State Event Definition Generation” Ser. No. 62/023,800, filed Jul. 11, 2014. The patent application “Mental State Event Definition Generation” Ser. No. 14/796,419, filed Jul. 10, 2015 is also a continuation-in-part of U.S. patent application “Mental State Analysis Using Web Services” Ser. No. 13/153,745, filed Jun. 6, 2011, which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011. The foregoing applications are each hereby incorporated by reference in their entirety.

### FIELD OF ART

This application relates generally to image analysis and more particularly to image analysis in support of robotic manipulation.

### BACKGROUND

With current technological advances, robots are used to perform useful tasks in a variety of platforms. Some robots are designed for only one function, such as welding robots used in an automobile manufacturing assembly line. This type of robot is designed to perform a repetitive task in potentially very harsh environments and is not tied to operating on a human schedule. As such, welding robots can be a very productive component of a manufacturing system. There are different kinds of robots that are able to perform multiple tasks, and some can even learn to perform new tasks. In addition, some robots can be controlled interactively via an external interface to a human being.

Robots are becoming more and more prevalent in society. At one time, robots, like the welding robot previously described, were primarily used in factories where conditions were conducive to repetitive motions in harsh environments. However, today's robots are much more sophisticated and are no longer only found in unfriendly manufacturing buildings. For example, robots are now able to self-navigate around a house in order to perform household vacuuming. As robots become more common in society, they are emerging as candidates for many tasks that were once reserved only for humans. Robots also include many other types of devices that may respond to human control.

As humans rely increasingly on communicating information to machines, the image analysis of a person or people can yield valuable insights and perspective. The face of a person is remarkably expressive and particularly effective for communication between and among people, mammals, and some other animals. Whether consciously or unconsciously, one person can relay to another a wide range of emotions and information through their facial expressions. The facial expressions are based on the movements or the positions of facial muscles and are used to exchange and communicate social information between people. The facial expressions convey emotions that range from happy to sad, and include angry, fearful, disgusted, and surprised, among many others.

Facial expressions can be captured and analyzed. Facial expression analysis is undertaken for purposes including determination of a range of emotions and mental states. The mental states include frustration, confusion, cognitive overload, skepticism, delight, satisfaction, calmness, stress, and more. An individual's mental state is a key indication of a person's emotional condition and may give insight into what that individual desires or needs.

Controlling a robot can be used to accomplish many things. A robot may respond to control through movement, lights, status indicators, articulation, and many such responses. Controlling a robot for various responses allows many different useful tasks to be implemented.

### SUMMARY

A series of images of an individual is obtained. The images are obtained using one or more cameras or another image capture apparatus. An image from the series of images is analyzed to capture mental state data. The analysis of the image is based on classifiers. The mental state data includes facial data for the individual. A mental state based on the mental state data which was captured is inferred. An instruction is provided to a robot based on the mental state that was inferred. The instruction to the robot produces in the robot one or more of motion, a location change, a color change, or a sound change.

In some embodiments, a processor-implemented method for robotic manipulation comprises: obtaining a series of images of an individual; analyzing an image from the series of images to capture mental state data, wherein the mental state data includes facial data for the individual; inferring a mental state based on the mental state data which was captured; and providing an instruction to a robot based on the mental state that was inferred. In some embodiments, the analyzing includes: identifying a human face from the image from the series of images; defining a region of interest (ROI) in the image that includes the identified human face; extracting one or more histogram-of-oriented-gradients (HoG) features from the ROI; and computing a set of facial metrics based on the one or more HoG features.

In some embodiments, the method includes identifying multiple human faces within the image from the series of images; defining a region of interest (ROI) in the image for each identified human face; extracting one or more histogram-of-oriented-gradients (HoG) features from each ROI; and computing a set of facial metrics based on the one or more HoG features for each of the multiple human faces. In some embodiments, the inferring of the mental state is further based on speech information from the individual. In some embodiments, the speech information includes tonal information, intonation, voice cadence, voice intensity, voice prosody, or voice pitch. In some embodiments, the speech information includes language information.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for image analysis and robot control.

FIG. 2 is a flow diagram for image and speech analysis

FIG. 3 illustrates a block diagram for facial analysis as it pertains to robotic manipulation.

FIG. 4 shows an example interaction between an individual, or person, and a robot.

FIG. 5 is a flow diagram for video analysis of multiple faces.

FIG. 6 shows example image collection including multiple mobile devices.

FIG. 7 illustrates facial data collection including landmarks.

FIG. 8 illustrates facial data collection including regions.

FIG. 9 illustrates feature extraction for multiple faces.

FIG. 10 is a flow diagram for detecting facial expressions.

FIG. 11 is a flow diagram for the large-scale clustering of facial events.

FIG. 12 shows unsupervised clustering of features and characterizations of cluster profiles.

FIG. 13 illustrates an example of live streaming.

FIG. 14A shows example tags embedded in a webpage.

FIG. 14B shows an example of invoking a tag to collect images.

FIG. 15 is a system for image analysis and robot control.

### DETAILED DESCRIPTION

Humans are continuously processing visual stimuli. They view their surroundings using their senses and process the views for a variety of purposes. The purposes for processing the views include locating objects to pick up or avoid, scanning for potential dangers, and identifying loved ones and friends, among many other tasks. Much of the processing is instinctual. For example, a sudden movement caught in a person's peripheral vision can cause a shift of attention to the source of the movement. The shift of attention can be due to fear, interest, and so on, and is made to identify the source of the movement. If the movement is a glint of sunlight caught by a wave on a lake, the source is probably harmless and can be appreciated or ignored. On the other hand, if the source of movement is of an imminent danger, then immediate, evasive action is required.

Humans observe each other's faces when they interact. Whether the interactions include sound, smell, touch, or any of the other senses, sight plays a critical role in social interaction. Sight is critical because the human face is highly expressive. The various facial expressions range widely and can convey a mental state of a person, an emotional state of a person, and so on. For example, a seductive smile communicates a very different message to the recipient of the smile than does an angry frown, while a neutral expression can indicate boredom, inattention, indifference, and so on. This exchange of “social information” between or among the participants in the interaction greatly influences how the interaction progresses. The smile may attract people to the interaction and retain them in it, while the angry frown can cause people to leave the interaction, perhaps with some haste. In this sense, facial expressions can control the interactions.

In the disclosed techniques, a series of images of an individual is captured. The images can be frames of a video or another image capture medium. The images are analyzed to capture mental state data of the individual. The analysis can use one or more classifiers. The mental state data includes facial data for the individual. Mental states are inferred based on the mental state data. An instruction is provided to a robot based on the mental state that was inferred. The instruction to the robot can produce motion in the robot. The motion can include translation, rotation, and so on. The instruction to the robot can cause the robot to change locations. The change in location can include changing location to a home position, a safe position, and so on. The instruction to the robot can be based on the distance from the robot to the individual. The instruction to the robot can produce a color change in the robot. The instruction to the robot can produce a sound change in the robot, including a sound response in a human-recognizable language. The instruction to the robot can result in the robot providing information to the individual. The instruction to the robot can result in the robot providing information to a third party. The instruction to the robot can produce a display change on the robot. For example, a person can smile and the robot can move toward the person. Likewise, a frown could cause the robot to move away from a person.

In some embodiments, it could be envisioned that a robot would be used to reinforce certain behaviors or provide entertainment. A child might be encouraged to smile and in response to a smile, the robot could move faster, light up, make sounds, and the like. As a child giggles, laughs, or expresses delight, the robot could similarly move or respond. A robot can be of an electromechanical type, or it can take a very different form, such as a social robot, a virtual assistant, a digital assistant, a voice assistant, or even a chat bot or an avatar. This class of social robots may or may not include any electromechanical responses, however the tasks and responses are nonetheless very useful. A robot response can be based on visual input, or speech and sound input, or a combination of both. The relative importance, or weighting, of the visual input or speech input in controlling a robot can be varied. A robot response can take the form of a movement, a color change, performing a task, or even responding to or answering a question, as is common with voice assistants such as Siri®, Cortana®, Google Now™, and Echo^{SM}. A robot response may take the form of a voice assistant response or an avatar update or a chat bot session, to name just a few responses.

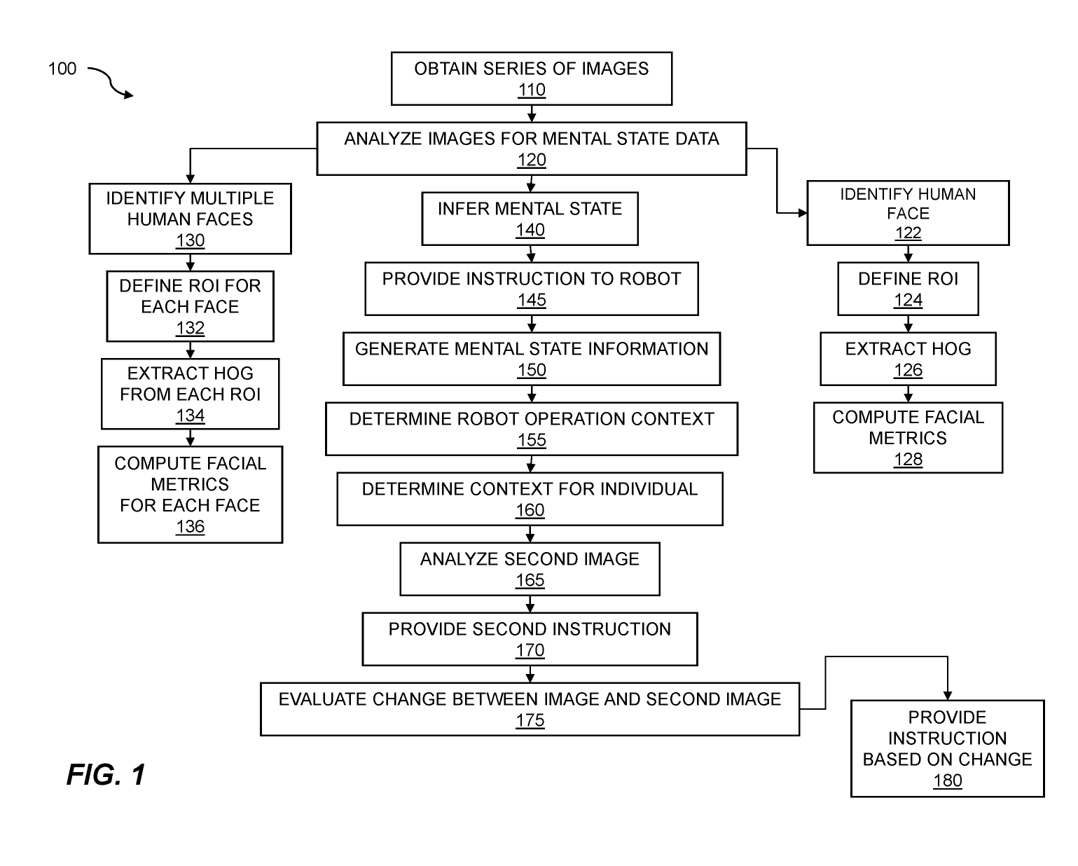

FIG. 1 is a flow diagram for image analysis and robot control. The flow 100 describes a computer-implemented method for robotic manipulation. The robotic manipulation can include various tasks that involve a robot, such as turning the robot on and off, instructing the robot to perform a range of operations including motion, indication, interaction, and so on. The robotic manipulation can include speech response or other non-motive response. The flow 100 includes obtaining a series of images 110 of an individual. The series of images 110 can be obtained by using a camera, where the camera can be coupled to an electronic device with which the individual is interacting. More than one camera can be used for the obtaining of a series of images. The camera or cameras can include a webcam, where a webcam can include a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. The series of images 110 can include facial images. The flow 100 includes analyzing an image from the series of images to capture mental state data 120, wherein the mental state data includes facial data for the individual. An image can be obtained from the series of images obtained from the one or more cameras. The series of images can be included in a video, where the video includes a plurality of frames. One or more sensors can provide additional mental state data on the individual. The additional sensors can be used to provide physiological data, for example, including heart rate, heart rate variability, electrodermal information, and so on. Other sensors can also be used. The analyzing can include facial expression analysis. An image, a frame, etc. can be analyzed to identify shapes, objects, environments, and so on.

The analyzing of the image can include the use of classifiers. Any number of classifiers can be used. The classifiers can be downloaded from the Internet, generated by a service, entered by the user, and so on. The analyzing can include detection of one or more of sadness, stress, happiness, anger, frustration, confusion, disappointment, hesitation, cognitive overload, focusing, engagement, attention, boredom, exploration, confidence, trust, delight, disgust, skepticism, doubt, satisfaction, excitement, laughter, calmness, curiosity, humor, sadness, poignancy, or mirth. The analysis can include detection of any mental state and any emotional state. The providing an instruction to the robot can be based on the detection. Other mental states, emotion, and so on, can also be detected. The analyzing can be accomplished using a software development kit (SDK). An SDK can be used to develop analysis applications. The analysis applications can be executed on an electronic device controlled by an individual, executed on a server, on a robot, and so on. An event signature is used to analyze the one or more images that can be obtained. An event signature can be identified in a media presentation displayed to one or more individuals. Mental state data can be timed to the one or more event signatures to determine mental states that can result in response to content in the media presentation, for example.

The flow 100 includes identifying a human face 122 within the image from the series of images. The identifying of the human face can be based on identifying facial landmarks, facial points, distinguishing marks, and so on. The identifying of the human face can include edge detection, gradient analysis, etc. The flow 100 includes defining a region of interest (ROI) 124 in the image that includes the identified human face. ROIs can include the eyes, mouth, nostrils, and so on. The regions of interest can include cells. The flow 100 includes extracting one or more histogram-of-oriented-gradients (HoG) 126 features from the ROI. The one or more HoGs can describe one or more features, where the feature can be a feature of a face, for example. The one or more HoGs can be used for feature detection in the image including detection of facial features. The flow 100 includes computing a set of facial metrics 128 based on the one or more HoG features. Facial metrics can include height of face, width of face, size of eyes, distance between eyes, distance between nose and mouth, and so on.

The flow 100 includes identifying multiple human faces 130 within the image from the series of images. The identifying of multiple human faces can include differentiating between one or more faces and a background in an image. The identifying can include further differentiating between two or more faces in the image, where the two or more faces can be fully visible, rotated, partially obscured, and so on. The flow 100 includes defining a region of interest (ROI) in the image for each identified human face 132. As was the case for a single face, regions of interest can be defined for two or more faces in an image. The regions of interest can include the eyes, mouth, nostrils, ears, eyebrows, and so on. The flow 100 includes extracting one or more histograms-of-oriented-gradients (HoG) features from each ROI 134. The two or more HoGs can be used for feature detection for each of the two or more faces in the image. The flow 100 includes computing a set of facial metrics based on the one or more HoG features for each of the multiple human faces 136. As was the case for a single face, facial metrics can be extracted for two or more faces in an image. The facial features can include height of face, width of face, size of eyes, distance between eyes, distance between nose and mouth, size of ears, position of ears, and so on

The flow 100 includes inferring a mental state 140 based on the mental state data which was captured. More than one mental state can be inferred from an analysis. The mental states can include one or more sadness, stress, happiness, anger, frustration, confusion, disappointment, hesitation, cognitive overload, focusing, engagement, attention, boredom, exploration, confidence, trust, delight, disgust, skepticism, doubt, satisfaction, excitement, laughter, calmness, curiosity, humor, sadness, poignancy, mirth, and so on. The flow 100 includes providing an instruction to a robot 145 based on the mental state that was inferred. The instruction to the robot can include controlling the robot. The instruction can be based on valence for the individual. The valence of the individual can include positive valence and negative valence. The control of the robot can include instruction to the robot to turn on or off, to perform various tasks, to undertake various movements, to interact with other robots, and so on.

The instructing the robot can produce motion in the robot. The motion in the robot can include translation, rotation, acceleration, deceleration, and so on. The instructing the robot can cause the robot to change locations. For example, the robot can be instructed to move from a first location to a second location, to return to a home location, to move to the person interacting with the robot, and so on. The instructing the robot can be based on a distance from the robot to the individual. For example, if the robot is located far from the individual, then the speed of the robot can be faster than if the robot is located near to the individual. The instructing the robot can include performing evasive movements to avoid the individual, including avoiding colliding with the individual. The instructing the robot can produce a color change in the robot. The instruction to the robot can include changing color from a first color to a second color, to a third color, and so on. The instruction the robot can include producing flashing colors. The instructing the robot can produce a sound change in the robot. For example, a sound change can include sounding an alarm, playing a message, playing music, and so on. The instructing the robot can produce an image change on a display on the robot. A display that can be coupled to the robot can be used to render data, images, videos, and other information. The display can be used to render welcome messages, warning messages, operational data, etc. The instructing the robot can include requests for information from a virtual assistant. The instructing the robot can include controlling an autonomous vehicle or a taxi robot. For example, frequent passenger grimaces while traveling over a bumpy road can cause an autonomous vehicle to slow down or even seek an alternative route.

The flow 100 includes generating mental state information 150 based on the analyzing of the image. The mental state information can include information on the mental states experienced by the individual. The mental state information can be aggregated, for example, and the aggregated mental state information can include one or more probabilities, and so on. The flow 100 includes determining context within which a robot is operating 155. The context can include information on the operating environment, time of day, date, temperature, weather conditions, and other parameters. The context within which the robot is operating can be used to select the instructions and types of instructions that can be issued to the robot. The flow 100 includes determining context for the individual 160. The context of the individual can include an environment, time and date, social information, news cycle information, and so on. The context of the individual can be used in the analysis of the mental state data of the individual. The context of the individual can also be used to determine the types of instructions that the individual might be likely to issue.

The flow 100 includes analyzing a second image 165 from the series of images. The second image can be the next image in the series or the previous image in the series of images. The second image can occur before the image or after the image in the series of images. The second image can be obtained from a camera other than the camera used to obtain the first image. The flow 100 includes providing a second instruction 170 to the robot based on the second image. As with the first image, the second instruction can include controlling the robot, where control of the robot can include movement such as translation and rotation, changing a color, changing a sound, and so on. The flow 100 includes evaluating a change between the image and the second image 175. There can be more than one change between the image and the second image. The change can include movement of the individual in the image, addition of one or more individuals, departure of one or more individuals, change of context, and so on. The change can occur over various time durations. The flow 100 includes the providing the instruction that is further based on the change 180. For example, if a second individual were to be determined in the second image, then the types of instruction issued to the robot can change. Similarly, the types of instructions that can be issued can be based on changes in context such as time of day, date, environment, and so on. Various steps in the flow 100 may be changed in order, repeated, omitted, or the like without departing from the disclosed concepts. Various embodiments of the flow 100 may be included in a computer program product embodied in a non-transitory computer readable medium that includes code executable by one or more processors.

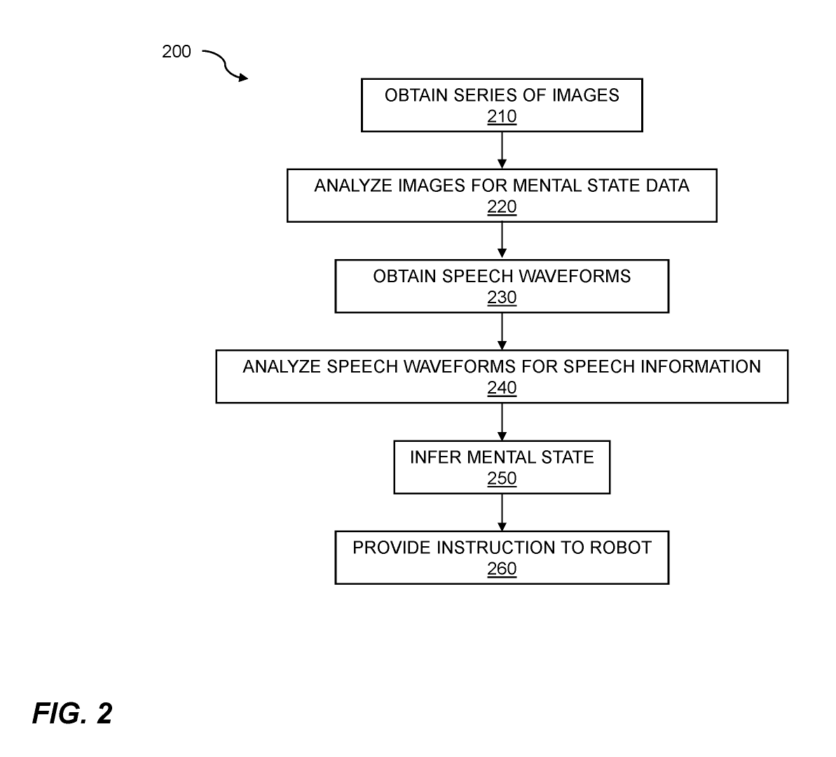

FIG. 2 is a flow diagram for image and speech analysis. Image analysis and speech analysis can be combined for robotic control. The flow 200 includes obtaining a series of images 210. The series of images 210 can include facial images. The series of images 210 can include images of one or more individuals. The series of images 210 are analyzed for mental state data 220. The flow 200 includes obtaining speech waveforms 230. The speech waveforms can be from the same or different individual/s as the series of images 210. The speech waveforms 230 are then analyzed for speech information 240. The speech information 240 can include tonal information, intonation, voice cadence, voice intensity, voice prosody, voice pitch, and other such speech information. The speech information 240 can include language information. The language information can come in the form of a request for information, such as a request for the current weather or the best driving route to avoid traffic delays. The robot response can be controlled based on the image data and the speech data. The robot control information can be modified by subsequent images or speech, even before the robot responds. Multiple control instructions and robot responses can be given based on the image and speech data. The image data and the speech data can both lead to the inference of the same, or a similar, mental state, thus reinforcing the mental state which is inferred. The reinforced mental state can cause a literal robot control instruction to be given, which follows the literal sense of the speech data that was captured. The image and speech data can each lead to the inference of different, or dissimilar, mental states, thus providing an ambiguous mental state which is inferred. The ambiguous mental state can cause a non-literal robot control instruction to be given, which does not follow the literal sense of the speech data that was captured.

The speech waveform 230 can be matched contemporaneously in time with one or more images of the series of images 210. The speech waveform 230 can be matched contemporaneously in time with an included time offset with one or more images of the series of images 210. The speech information 240 can be combined with the analyzed images for mental state data 220 and used to infer a mental state 250. The mental state 250 can be weighted more heavily with the image mental state data 220. The mental state 250 can be weighted more heavily with the speech information 240. The mental state data 220 and the speech information 240 can be weighted equally in the inferring of the mental state 250. For example, a smile on one or more individuals can be analyzed to produce a mental state of happiness or agreement which is normally weighted heavily in inferring mental states. However, if the image is accompanied by a speech waveform that contains the word “stop” and is spoken loudly and sharply, the speech information can be weighted more heavily than the smile image. The flow 200 includes providing an instruction to the robot 260. The instruction to the robot 260 can be based on the inferred mental states 250. One or more instructions to the robot 260 can be provided based on one or more inferred mental states. The one or more instructions can elicit a robot response to an individual. The one or more instructions can elicit a robot response to more than one individual. The one or more instructions can elicit a robot response to a third party or parties who were not involved in the image or speech capture. Various steps in the flow 200 may be changed in order, repeated, omitted, or the like without departing from the disclosed concepts. Various embodiments of the flow 200 may be included in a computer program product embodied in a non-transitory computer readable medium that includes code executable by one or more processors.

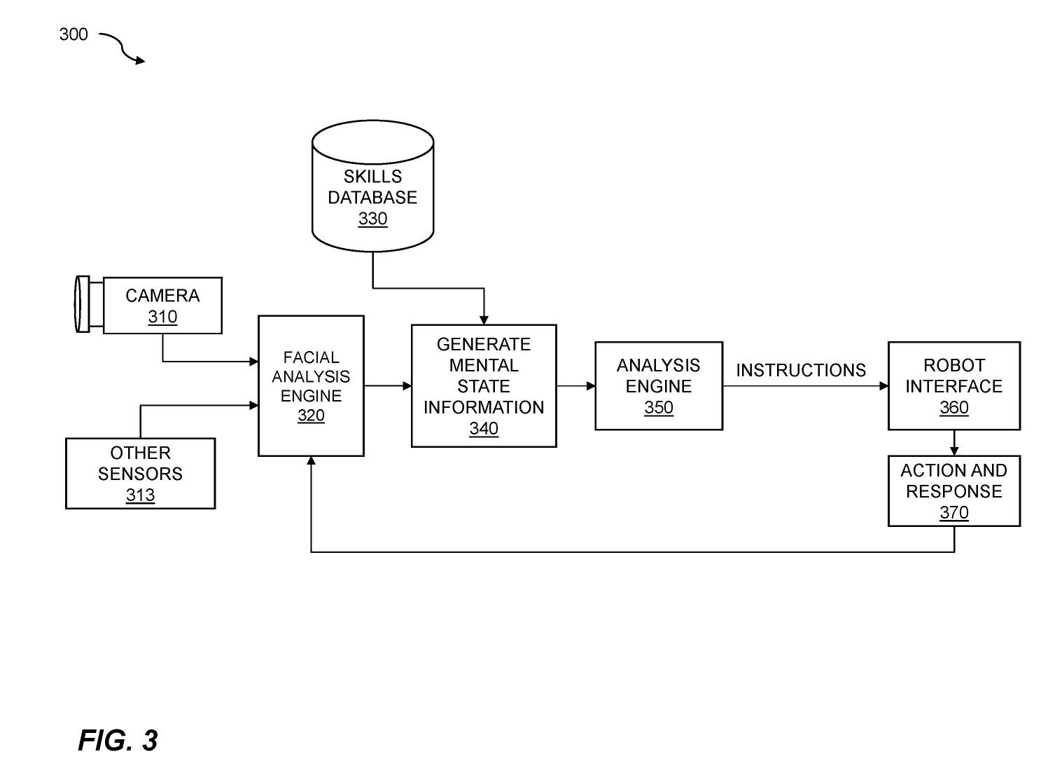

FIG. 3 illustrates a block diagram for facial analysis as it pertains to robotic manipulation. The block diagram 300 includes a camera 310. The camera 310 can capture an image or a series of images. More than one camera can be used. The camera or cameras can include a webcam, where a webcam can include a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. The camera 310 can be coupled to a facial analysis engine 320. Other sensors 313 can also be coupled to the analysis engine to augment facial analysis. The other sensors 313 could include biosensors evaluating electrodermal activity, heart rate, perspiration, respiration, blood sugar, and the like. The facial analysis engine can analyze an image from the series of images and can capture mental state data, where the mental state data can include facial data for the individual. The facial analysis engine 320 can be coupled to a mental state information generator 340. The mental state information generator can generate the mental state information for an individual or a plurality of individuals. The mental state information generator can augment the facial analysis data from the facial analysis engine 320. The augmented information can include a voice, a context such as an environment, time and date, social information, news cycle information, and so on. The mental state information generator can be coupled to a skills database 330. The skills database 330 can include filtering information, temporal information, logical information, and so on. The mental state information generator can be coupled to an analysis engine 350. The analysis engine can be based on behavioral models. The analysis engine can generate instructions for a robot based on the facial analysis and the mental state information that can be generated. The instructions from the analysis engine can be sent to a robot interface 360. The instructions can be sent to the robot using a wireless link, a wired link, and so on. The robot interface 360 can include a connection module whether wired, wireless, or a combination thereof, a control module, and so on. In some embodiments, a camera or audio sensor is enabled on the robot in response to facial expressions. The instructions can be sent to an action and response module 370. The action and response module 370 can execute the instructions that are received. The instructions can include commands to a robot, such as commands to move the robot, where movement of the robot can include translational movement, rotational movement, and so on. The instructions can also include commands to enable and disable an indicator coupled to the robot. For example, if the indicator is a lamp, the instructions could command that the lamp be turned on, turned off, perform a color change, and so on. The action and response module 370 can feed back to the facial analysis module so that any changes in facial expression, for example, can be used to generate one or more new commands for the robot.

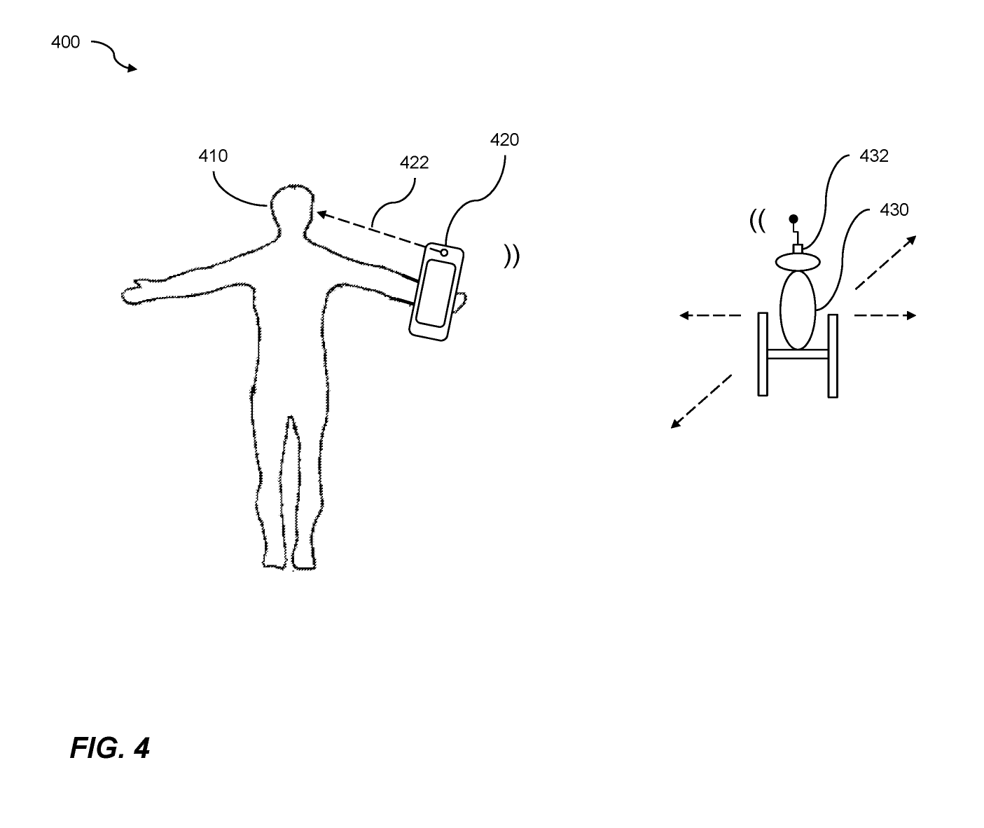

FIG. 4 shows an example interaction 400 between an individual, or person, and a robot. A person 410 can interact with a robot 430 using a variety of techniques, including using an electronic device 420. The electronic device can be a portable electronic device as shown or another electronic device appropriate to controlling the robot 430. The electronic device can be coupled to a camera, where the camera can be built-in to the electronic device, external to the electronic device, and so on. The camera that can be coupled to the electronic device 420 can have a line of sight 422 to the person 410. The camera can be used to capture an image or a series of images of an individual 410. The captured image or images can be analyzed to capture mental state data. The processing of the image or images can take place on the electronic device 420, can be sent to a remote server for processing, and so on. The electronic device 420 can be used to infer a mental state based on the mental state data which was captured, where the mental state data can include facial data for the individual. Other data including physiological data can also be captured using the electronic device 420. The electronic device 420 can be used to provide an instruction to a robot 430. The instruction can be based on the mental state data that can be inferred. The instruction can be sent to the robot using a wireless connection (shown), using a wired connection, using a hybrid connection, and so on. The wireless connection, for example, can be established using any wireless networking protocol including Wi-Fi, Bluetooth™, cellular (e.g. 3G, 4G, LTE), Zigbee™, and so on. The instruction or instructions can be used to move the robot as indicated by the arrows. The robot can move in any direction, can turn around, etc. The robot can be coupled to an indicator 432. The indicator can be a lamp which can change colors, a bell, a siren, a sound generator, a speech generator, and so on. The indicator 432 can change color, for example, based on the instruction that can be sent to the robot 430. The indicator 432 can be a voice response from a virtual assistant robot.

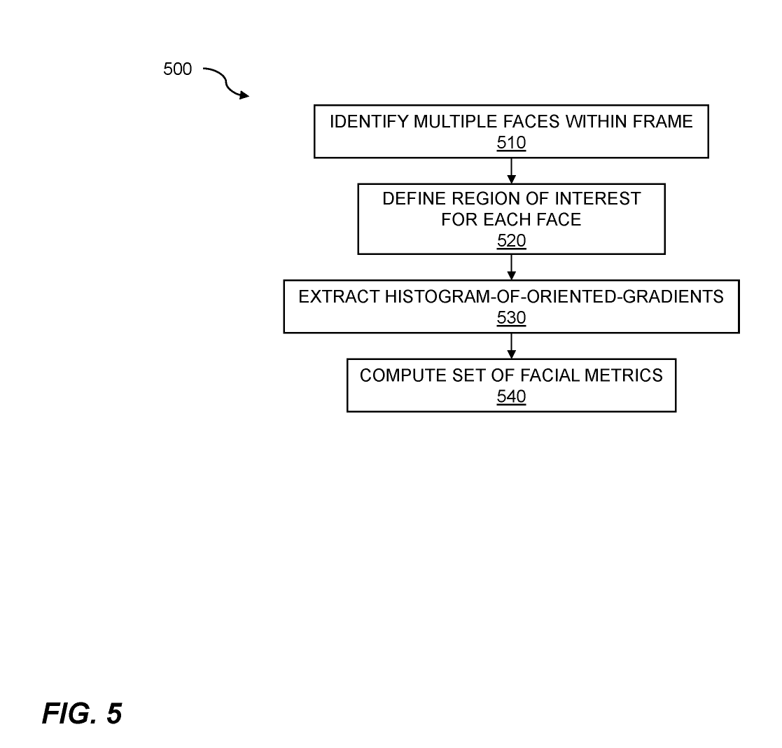

FIG. 5 is a flow diagram for video analysis of multiple faces. The video analysis is used to control responses of one or more robots. In some embodiments, it is expedient of the present disclosure to evaluate the mental states of a plurality of people, including a unified audience. For example, a wide-angle camera can be positioned such that it captures the faces of multiple people sitting in a room watching one or more robots. The robot or robots can be performing tasks, providing amusement, solving problems, working together, competing, and so on. One or more people can be controlling the one or more robots. The wide-angle camera can capture video, where the video can include multiple frames, multiple images, and so on. Each frame, for example, can contain multiple faces. In embodiments, the camera can be an infrared camera that can be used in low light conditions, such as in a movie theater, for example. Each frame of such a video will contain multiple faces. In embodiments, the frames contain more than one face, with some embodiments containing more than 200 faces. The flow 500 starts by identifying the multiple faces within a frame 510. The flow 500 continues with defining a region of interest for each face 520. After the defining, a HoG 530 can be extracted for each region of interest. The flow 500 then continues with computing a set of facial metrics 540 for each face that was detected. In this way, multiple faces can be simultaneously analyzed with a single camera. Embodiments further include smoothing each metric from the set of facial metrics. In some embodiments, the smoothing is performed using a Gaussian filter. Thus, embodiments include identifying multiple human faces within a frame of a video selected from the plurality of videos; defining a region of interest (ROI) in the frame for each identified human face; extracting one or more HoG features from each ROI; and computing a set of facial metrics based on the one or more HoG features for each of the multiple human faces. Various steps in the flow 500 may be changed in order, repeated, omitted, or the like without departing from the disclosed concepts. Various embodiments of the flow 500 may be included in a computer program product embodied in a non-transitory computer readable medium that includes code executable by one or more processors.

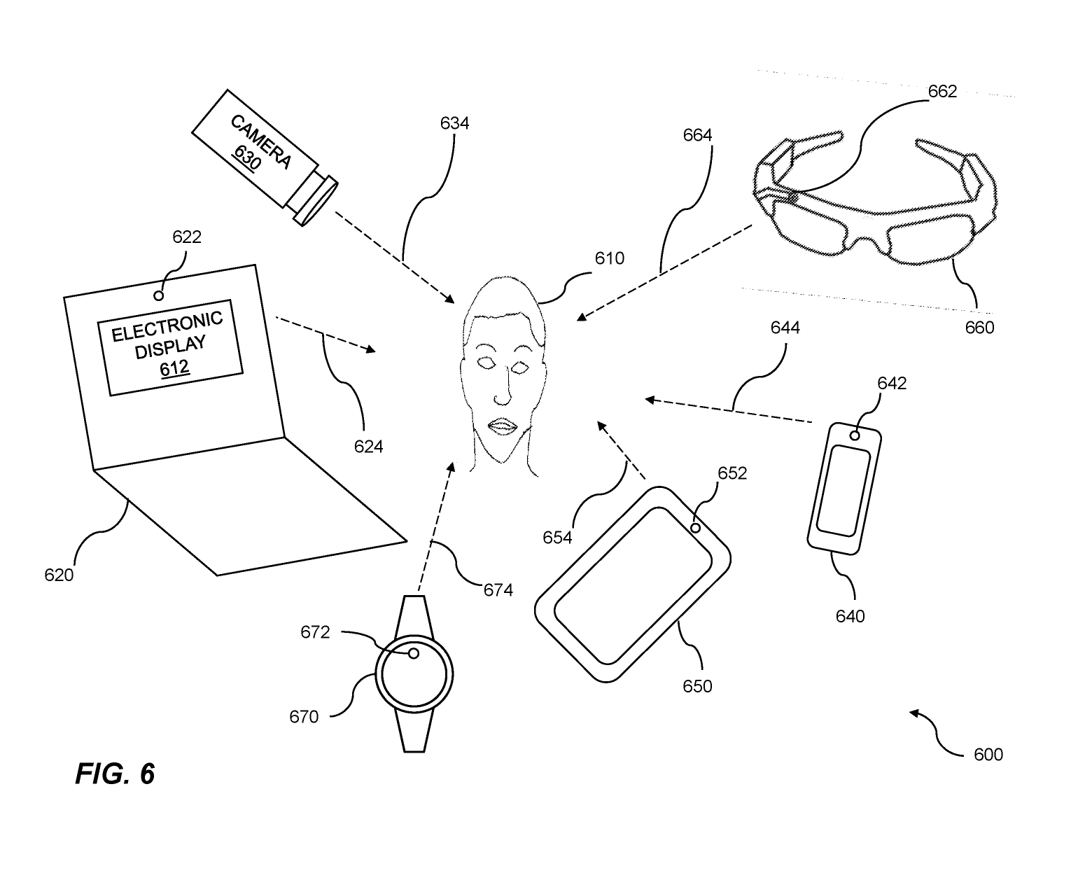

FIG. 6 shows example image collection including multiple mobile devices 600. One or more of these multiple mobile devices can collect facial expression information, and that expression information can be used to control robots. The multiple mobile devices can be used to collect video data on a person. While one person is shown, in practice the video data on any number of people can be collected. A user 610 can be observed as she or he is performing a task, controlling a robot, experiencing an event, viewing a media presentation, and so on. The user 610 can be controlling one or more robots, for example, or viewing a media presentation or another form of displayed media. The one or more robots, for example, can be visible to a plurality of people instead of an individual user. If the plurality of people is viewing a media presentation, then the media presentations can be displayed on an electronic display 612. The data collected on the user 610 or on a plurality of users can be in the form of one or more videos. The plurality of videos can be of people who are experiencing different situations. Some example situations can include the user or plurality of users viewing one or more robots performing various tasks. The situations could also include exposure to media such as advertisements, political messages, news programs, and so on. As noted before, video data can be collected on one or more users in substantially identical or different situations who are viewing either a single robot or a plurality of robots, for example. The data collected on the user 610 can be analyzed and viewed for a variety of purposes, including expression analysis. The electronic display 612 can be on a laptop computer 620 as shown, a tablet computer 650, a cell phone 640, a television, a mobile monitor, or any other type of electronic device. In a certain embodiment, expression data is collected on a mobile device such as a cell phone 640, a tablet computer 650, a laptop computer 620, or a watch 670. Thus, the multiple sources can include at least one mobile device such as a cell phone 640 or a tablet computer 650, or a wearable device such as a watch 670 or glasses 660. A mobile device can include a forward facing camera and/or a rear-facing camera that can be used to collect expression data. Sources of expression data can include a webcam 622, a phone camera 642, a tablet camera 652, a wearable camera 662, and a mobile camera 630. A wearable camera can comprise various camera devices such as the watch camera 672.

As the user 610 is monitored, the user 610 might move due to the nature of the task, boredom, discomfort, distractions, or for another reason. As the user moves, the camera with a view of the user's face can change. Thus, as an example, if the user 610 is looking in a first direction, the line of sight 624 from the webcam 622 is able to observe the individual's face, but if the user is looking in a second direction, the line of sight 634 from the mobile camera 630 is able to observe the individual's face. Further, in other embodiments, if the user is looking in a third direction, the line of sight 644 from the phone camera 642 is able to observe the individual's face, and if the user is looking in a fourth direction, the line of sight 654 from the tablet camera 652 is able to observe the individual's face. If the user is looking in a fifth direction, the line of sight 664 from the wearable camera 662, which can be a device such as the glasses 660 shown and can be worn by another user or an observer, is able to observe the individual's face. If the user is looking in a sixth direction, the line of sight 674 from the wearable watch-type device 670 with a camera 672 included on the device, is able to observe the individual's face. In other embodiments, the wearable device is another device, such as an earpiece with a camera, a helmet or hat with a camera, a clip-on camera attached to clothing, or any other type of wearable device with a camera or another sensor for collecting expression data. The user 610 can also employ a wearable device including a camera for gathering contextual information and/or collecting expression data on other users. Because the user 610 can move her or his head, the facial data can be collected intermittently when the individual is looking in a direction of a camera. In some cases, multiple people are included in the view from one or more cameras, and some embodiments include filtering out faces of one or more other people to determine whether the user 610 is looking toward a camera. All or some of the expression data can be continuously or sporadically available from these various devices and other devices.

The captured video data can include facial expressions and can be analyzed on a computing device, such as the video capture device or on another separate device. The analysis of the video data can include the use of a classifier. For example, the video data can be captured using one of the mobile devices discussed above and sent to a server or another computing device for analysis. However, the captured video data including expressions can also be analyzed on the device which performed the capturing. For example, the analysis can be performed on a mobile device, where the videos were obtained with the mobile device and wherein the mobile device includes one or more of a laptop computer, a tablet, a PDA, a smartphone, a wearable device, and so on. In another embodiment, the analyzing comprises using a classifier on a server or other computing device other than the capturing device. The result of the analyzing can be used to control motions, sounds, displays, and the like for one or more robots.

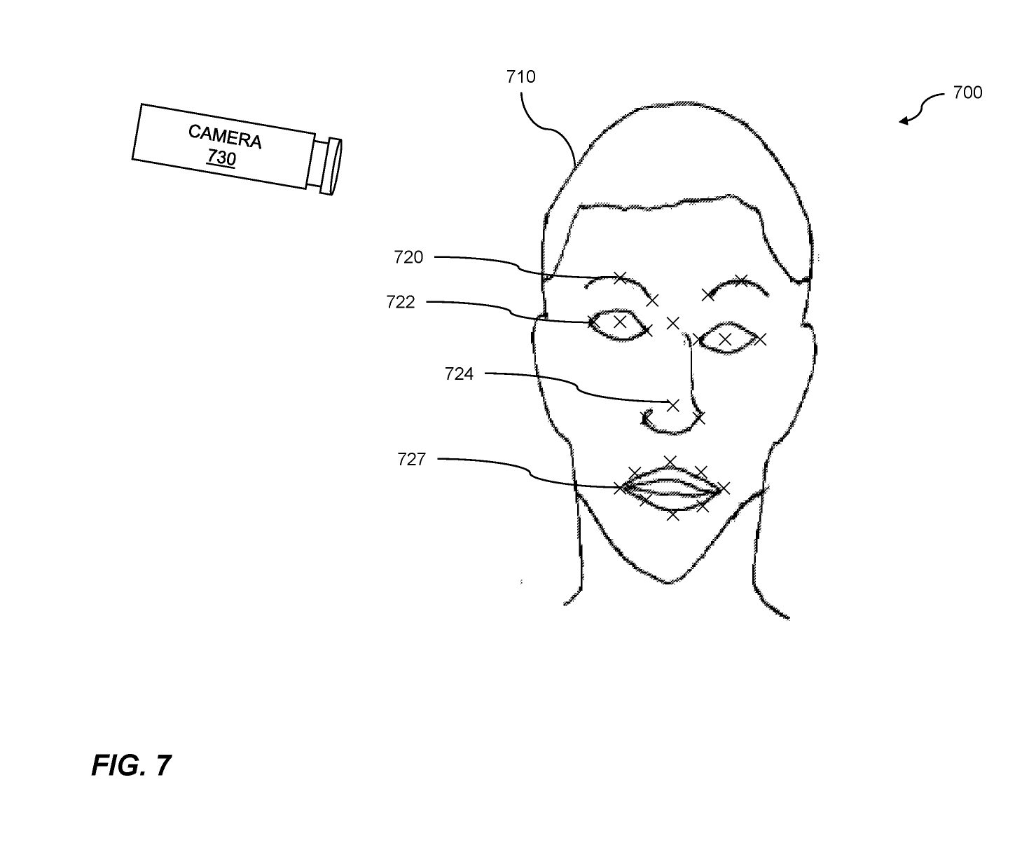

FIG. 7 shows a diagram 700 illustrating example facial data collection including landmarks. The facial data that is collected can be used to provide instructions to/manipulate robots. A face 710 can be observed using a camera 730 in order to collect facial data that includes facial landmarks. The facial data can be collected from a plurality of people using one or more of a variety of cameras. As discussed above, the camera or cameras can include a webcam, where a webcam can include a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. The quality and usefulness of the facial data that is captured can depend, for example, on the position of the camera 730 relative to the face 710, the number of cameras used, the illumination of the face, etc. For example, if the face 710 is poorly lit or over-exposed (e.g. in an area of bright light), the processing of the facial data to identify facial landmarks might be rendered more difficult. In another example, the camera 730 being positioned to the side of the person might prevent capture of the full face. Other artifacts can degrade the capture of facial data. For example, the person's hair, prosthetic devices (e.g. glasses, an eye patch, and eye coverings), jewelry, and clothing can partially or completely occlude or obscure the person's face. Data relating to various facial landmarks can include a variety of facial features. The facial features can comprise an eyebrow 720, an outer eye edge 722, a nose 724, a corner of a mouth 727, and so on. Any number of facial landmarks can be identified from the facial data that is captured. The facial landmarks that are identified can be analyzed to identify facial action units. For example, the action units that can be identified include AU02 outer brow raiser, AU14 dimpler, AU17 chin raiser, and so on. Any number of action units can be identified. The action units can be used alone and/or in combination to infer one or more mental states and emotions. A similar process can be applied to gesture analysis (e.g. hand gestures). The resulting analysis can impact control of or augment control of a robot.

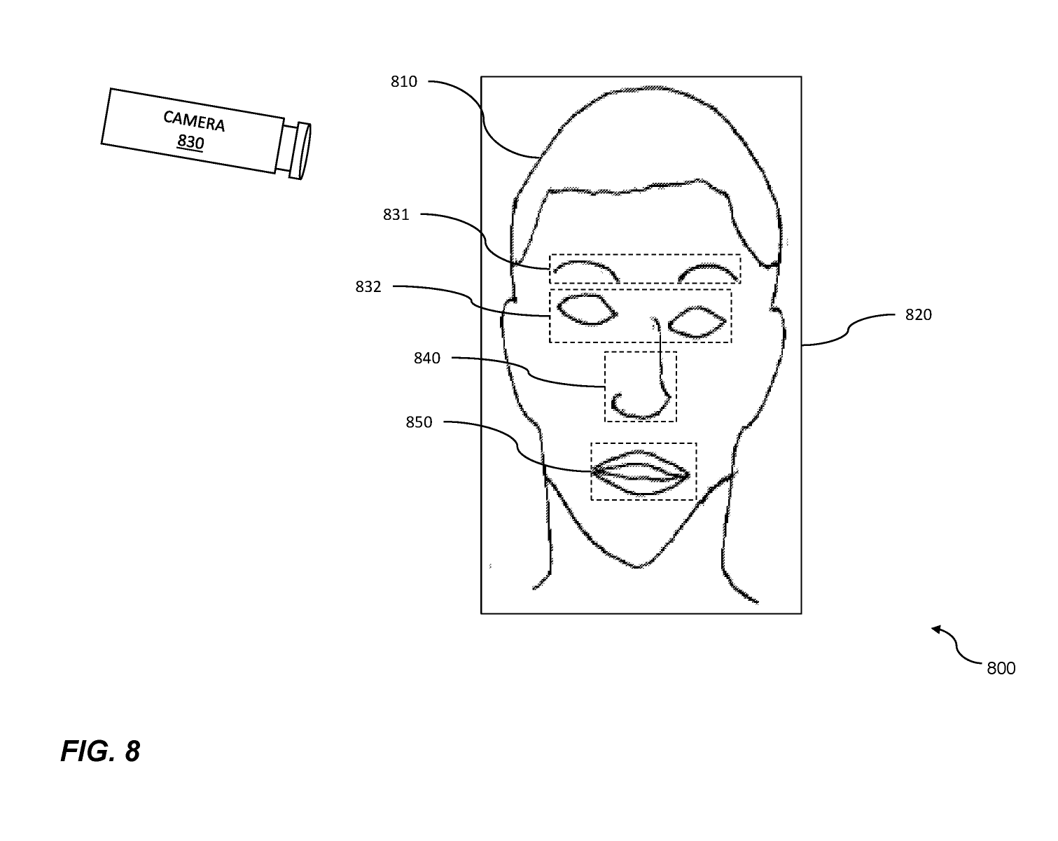

FIG. 8 illustrates facial data collection including regions. The facial data that is collected can be used to provide instructions to/manipulate robots. The regions can be evaluated within a deep learning environment. The collecting of facial data including regions can be performed for images collected of an individual. The collected images can be analyzed for mental states and/or facial expressions. A plurality of images of an individual viewing an electronic display can be received. A face can be identified in an image, based on the use of classifiers. The plurality of images can be evaluated to determine mental states and/or facial expressions of the individual. Various regions of a face can be identified and used for a variety of purposes including facial recognition, facial analysis, and so on. The collecting of facial data including regions can be based on sub-sectional components of a population. The sub-sectional components can be used with performing the evaluation of content of the face, identifying facial regions, etc. The sub-sectional components can be used to provide a context. Facial analysis can be used to determine, predict, and estimate mental states and emotions of a person from whom facial data can be collected.

In embodiments, the one or more emotions determined by the analysis are represented by an image, a figure, an icon, etc. The representative icon can include an emoji or emoticon. One or more emoji can be used to represent a mental state, emotion, or mood of an individual; to represent food, a geographic location, weather, and so on. The emoji can include a static image. The static image can be a predefined size such as a certain number of pixels. The emoji can include an animated image. The emoji can be based on a GIF or another animation standard. The emoji can include a cartoon representation. The cartoon representation can be any cartoon type, format, etc., that can be appropriate to representing an emoji. In the example 800, facial data can be collected, where the facial data can include regions of a face. The facial data that is collected can be based on sub-sectional components of a population. When more than one face can be detected in an image, facial data can be collected for one face, some faces, all faces, and so on. The facial data which can include facial regions can be collected using any of a variety of electronic hardware and software techniques. The facial data can be collected using sensors including motion sensors, infrared sensors, physiological sensors, imaging sensors, and so on. A face 810 can be observed using a camera 830, a sensor, a combination of cameras and/or sensors, and so on. The camera 830 can be used to collect facial data that can be used to determine that a face is present in an image. When a face is present in an image, a bounding box 820 can be placed around the face. Placement of the bounding box around the face can be based on detection of facial landmarks. The camera 830 can be used to collect facial data from the bounding box 820, where the facial data can include facial regions. The facial data can be collected from a plurality of people using any of a variety of cameras. As discussed previously, the camera or cameras can include a webcam, where a webcam can include a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. As discussed previously, the quality and usefulness of the facial data that is captured can depend on, among other examples, the position of the camera 830 relative to the face 810, the number of cameras and/or sensors used, the illumination of the face, any obstructions to viewing the face, and so on.

The facial regions that can be collected by the camera 830, a sensor, or a combination of cameras and/or sensors can include any of a variety of facial features. Embodiments include determining regions within the face of the individual and evaluating the regions for emotional content. The facial features that can be included in the facial regions that are collected can include eyebrows 831, eyes 832, a nose 840, a mouth 850, ears, hair, texture, tone, and so on. Multiple facial features can be included in one or more facial regions. The number of facial features that can be included in the facial regions can depend on the desired amount of data to be captured, whether a face is in profile, whether the face is partially occluded or obstructed, etc. The facial regions that can include one or more facial features can be analyzed to determine facial expressions. The analysis of the facial regions can also include determining probabilities of occurrence of one or more facial expressions. The facial features that can be analyzed can also include features such as textures, gradients, colors, and shapes. The facial features can be used to determine demographic data, where the demographic data can include age, ethnicity, culture, and gender. Multiple textures, gradients, colors, shapes, and so on, can be detected by the camera 830, a sensor, or a combination of cameras and sensors. Texture, brightness, and color, for example, can be used to detect boundaries in an image for detection of a face, facial features, facial landmarks, and so on.

A texture in a facial region can include facial characteristics, skin types, and so on. In some instances, a texture in a facial region can include smile lines, crow's feet, and wrinkles, among others. Another texture that can be used to evaluate a facial region can include a smooth portion of skin such as a smooth portion of a check. A gradient in a facial region can include values assigned to local skin texture, shading, etc. A gradient can be used to encode a texture by computing magnitudes in a local neighborhood or portion of an image. The computed values can be compared to discrimination levels, threshold values, and so on. The gradient can be used to determine gender, facial expression, etc. A color in a facial region can include eye color, skin color, hair color, and so on. A color can be used to determine demographic data, where the demographic data can include ethnicity, culture, age, and gender. A shape in a facial region can include the shape of a face, eyes, nose, mouth, ears, and so on. As with color in a facial region, shape in a facial region can be used to determine demographic data including ethnicity, culture, age, gender, and so on.

The facial regions can be detected based on detection of edges, boundaries, and so on, of features that can be included in an image. The detection can be based on various types of analysis of the image. The features that can be included in the image can include one or more faces. A boundary can refer to a contour in an image plane, where the contour can represent ownership of a particular picture element (pixel) from one object, feature, etc. in the image, to another object, feature, and so on, in the image. An edge can be a distinct, low-level change of one or more features in an image. That is, an edge can be detected based on a change, including an abrupt change such as in color or brightness within an image. In embodiments, image classifiers are used for the analysis. The image classifiers can include algorithms, heuristics, and so on, and can be implemented using functions, classes, subroutines, code segments, etc. The classifiers can be used to detect facial regions, facial features, and so on. As discussed above, the classifiers can be used to detect textures, gradients, color, shapes, and edges, among others. Any classifier can be used for the analysis, including, but not limited to, density estimation, support vector machines (SVM), logistic regression, classification trees, and so on. By way of example, consider facial features that can include the eyebrows 831. One or more classifiers can be used to analyze the facial regions that can include the eyebrows to determine a probability for either a presence or an absence of an eyebrow furrow. The probability can include a posterior probability, a conditional probability, and so on. The probabilities can be based on Bayesian Statistics or other statistical analysis technique. The presence of an eyebrow furrow can indicate that the person from whom the facial data was collected is annoyed, confused, unhappy, and so on. In another example, consider facial features that can include a mouth 850. One or more classifiers can be used to analyze the facial region that can include the mouth to determine a probability for either a presence or an absence of mouth edges turned up to form a smile. Multiple classifiers can be used to determine one or more facial expressions. The classifiers and the facial expressions can be used in providing instructions to and manipulating robots.

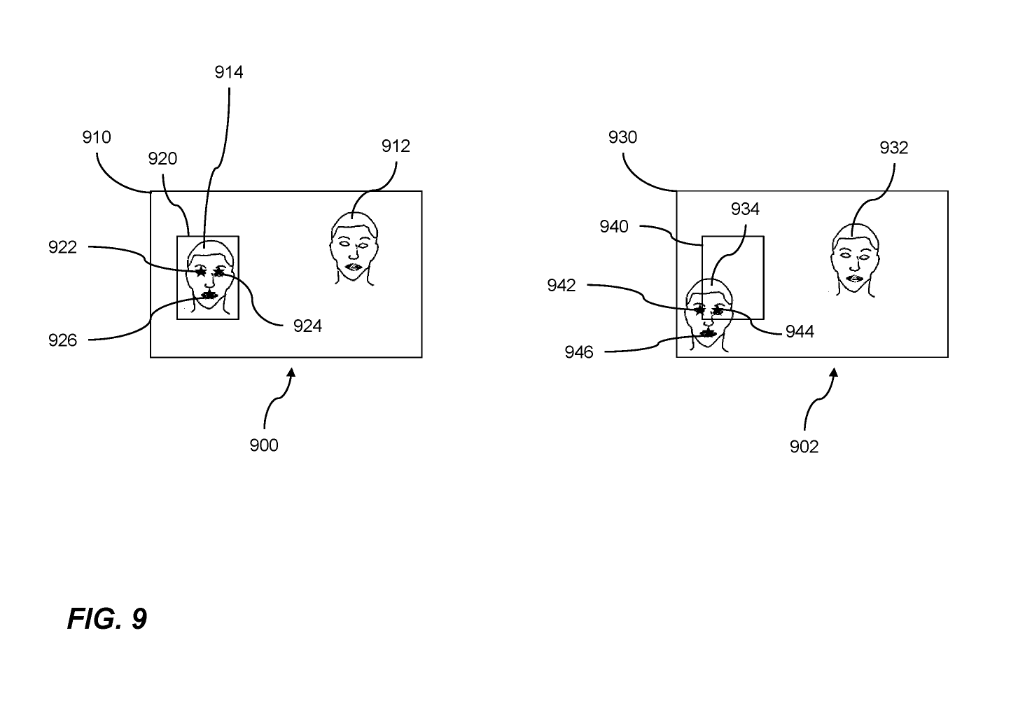

FIG. 9 illustrates feature extraction for multiple faces. The features can be evaluated within a deep learning environment. The feature extraction for multiple faces can be performed for faces that can be detected in multiple images. The images can be analyzed for mental states and/or facial expressions. The mental states and/or facial expressions can be used to provide instructions to/manipulate robots. A plurality of images can be received of an individual viewing an electronic display. A face can be identified in an image, based on the use of classifiers. The plurality of images can be evaluated to determine mental states and/or facial expressions of the individual. The feature extraction can be performed by analysis using one or more processors, using one or more video collection devices, and by using a server. The analysis device can be used to perform face detection for a second face, as well as for facial tracking of the first face. One or more videos can be captured, where the videos contain one or more faces. The video or videos that contain the one or more faces can be partitioned into a plurality of frames, and the frames can be analyzed for the detection of the one or more faces. The analysis of the one or more video frames can be based on one or more classifiers. A classifier can be an algorithm, heuristic, function, or piece of code that can be used to identify into which of a set of categories a new or particular observation, sample, datum, etc., should be placed. The decision to place an observation into a category can be based on training the algorithm or piece of code, by analyzing a known set of data, known as a training set. The training set can include data for which category memberships of the data can be known. The training set can be used as part of a supervised training technique. If a training set is not available, then a clustering technique can be used to group observations into categories. The latter approach, or unsupervised learning, can be based on a measure (i.e. distance) of one or more inherent similarities among the data that is being categorized. When the new observation is received, then the classifier can be used to categorize the new observation. Classifiers can be used for many analysis applications, including analysis of one or more faces. The use of classifiers can be the basis of analyzing the one or more faces for gender, ethnicity, and age; for detection of one or more faces in one or more videos; for detection of facial features, for detection of facial landmarks, and so on. The observations can be analyzed based on one or more of a set of quantifiable properties. The properties can be described as features and explanatory variables and can include various data types that can include numerical (integer-valued, real-valued), ordinal, categorical, and so on. Some classifiers can be based on a comparison between an observation and prior observations, as well as based on functions such as a similarity function, a distance function, and so on.

Classification can be based on various types of algorithms, heuristics, codes, procedures, statistics, and so on. Many techniques exist for performing classification. This classification of one or more observations into one or more groups can be based on distributions of the data values, probabilities, and so on. Classifiers can be binary, multiclass, linear, and so on. Algorithms for classification can be implemented using a variety of techniques, including neural networks, kernel estimation, support vector machines, use of quadratic surfaces, and so on. Classification can be used in many application areas such as computer vision, speech and handwriting recognition, and so on. Classification can be used for biometric identification of one or more people in one or more frames of one or more videos.

Returning to FIG. 9, the detection of the first face, the second face, and multiple faces can include identifying facial landmarks, generating a bounding box, and prediction of a bounding box and landmarks for a next frame, where the next frame can be one of a plurality of frames of a video containing faces. A first video frame 900 includes a frame boundary 910, a first face 912, and a second face 914. The video frame 900 also includes a bounding box 920. Facial landmarks can be generated for the first face 912. Face detection can be performed to initialize a second set of locations for a second set of facial landmarks for a second face within the video. Facial landmarks in the video frame 900 can include the facial landmarks 922, 924, and 926. The facial landmarks can include corners of a mouth, corners of eyes, eyebrow corners, the tip of the nose, nostrils, chin, the tips of ears, and so on. The performing of face detection on the second face can include performing facial landmark detection with the first frame from the video for the second face and can include estimating a second rough bounding box for the second face based on the facial landmark detection. The estimating of a second rough bounding box can include the bounding box 920. Bounding boxes can also be estimated for one or more other faces within the boundary 910. The bounding box can be refined, as can one or more facial landmarks. The refining of the second set of locations for the second set of facial landmarks can be based on localized information around the second set of facial landmarks. The bounding box 920 and the facial landmarks 922, 924, and 926 can be used to estimate future locations for the second set of locations for the second set of facial landmarks in a future video frame from the first video frame.

A second video frame 902 is also shown. The second video frame 902 includes a frame boundary 930, a first face 932, and a second face 934. The second video frame 902 also includes a bounding box 940 and the facial landmarks 942, 944, and 946. In other embodiments, multiple facial landmarks are generated and used for facial tracking of the two or more faces of a video frame, such as the shown second video frame 902. Facial points from the first face can be distinguished from other facial points. In embodiments, the other facial points include facial points of one or more other faces. The facial points can correspond to the facial points of the second face. The distinguishing of the facial points of the first face and the facial points of the second face can be used to distinguish between the first face and the second face, to track either or both of the first face and the second face, and so on. Other facial points can correspond to the second face. As mentioned above, multiple facial points can be determined within a frame. One or more of the other facial points that are determined can correspond to a third face. The location of the bounding box 940 can be estimated, where the estimating can be based on the location of the generated bounding box 920 shown in the first video frame 900. The three facial landmarks shown, facial landmarks 942, 944, and 946, might lie within the bounding box 940 or might not lie partially or completely within the bounding box 940. For instance, the second face 934 might have moved between the first video frame 900 and the second video frame 902. Based on the accuracy of the estimating of the bounding box 940, a new estimation can be determined for a third, future frame from the video, and so on. The evaluation can be performed, all or in part, on semiconductor based logic. The evaluation can be used in providing instructions to and manipulating robots.

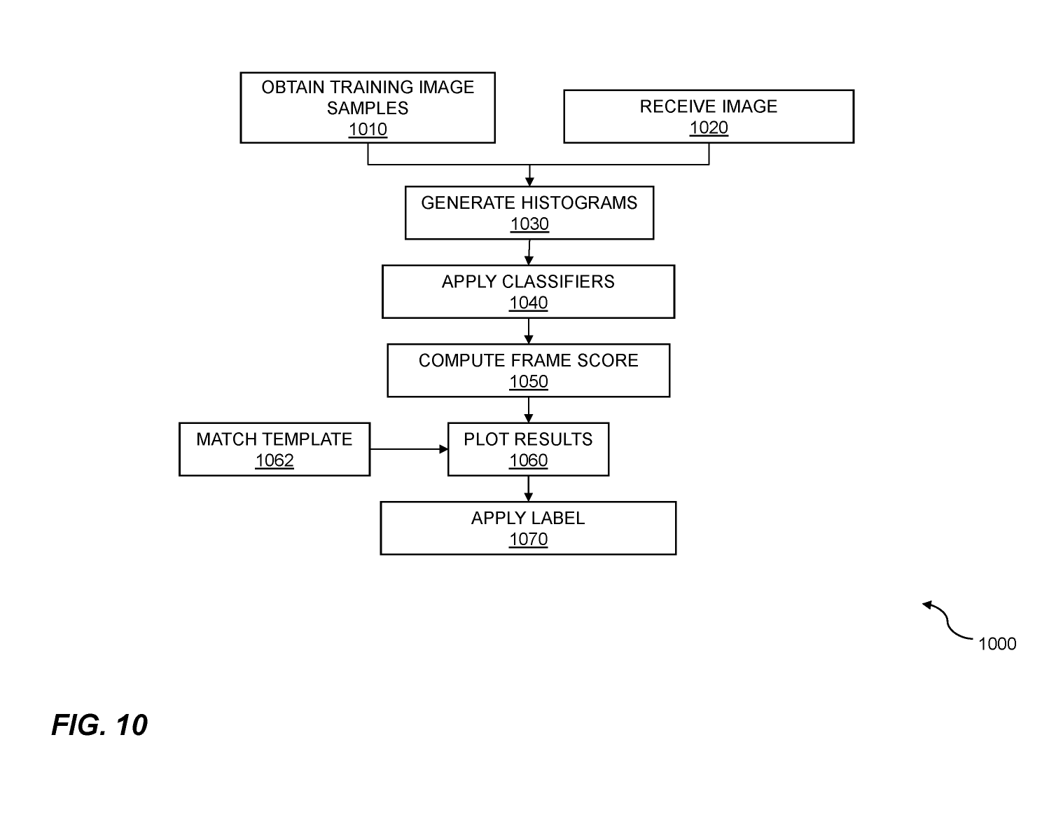

FIG. 10 is a flow diagram for detecting facial expressions. The detection of facial expressions can be performed for data collected from images of an individual and used within a deep learning environment. The collected images can be analyzed for mental states and/or facial expressions. The mental states and/or facial expressions can be used to provide instructions to robots, or to manipulate robots. A plurality of images can be received of an individual viewing an electronic display. A face can be identified in an image, based on the use of classifiers. The plurality of images can be evaluated to determine the mental states and/or facial expressions the individual. The flow 1000, or portions thereof, can be implemented in semiconductor logic, can be accomplished using a mobile device, can be accomplished using a server device, and so on. The flow 1000 can be used to automatically detect a wide range of facial expressions. A facial expression can produce strong emotional signals that can indicate valence and discrete emotional states. The discrete emotional states can include contempt, doubt, defiance, happiness, fear, anxiety, and so on. The detection of facial expressions can be based on the location of facial landmarks. The detection of facial expressions can be based on determination of action units (AU), where the action units are determined using FACS coding. The AUs can be used singly or in combination to identify facial expressions. Based on the facial landmarks, one or more AUs can be identified by number and intensity. For example, AU12 can be used to code a lip corner puller and can be used to infer a smirk.

The flow 1000 begins by obtaining training image samples 1010. The image samples can include a plurality of images of one or more people. Human coders who are trained to correctly identify AU codes based on the FACS can code the images. The training or “known good” images can be used as a basis for training a machine learning technique. Once trained, the machine learning technique can be used to identify AUs in other images that can be collected using a camera, a sensor, and so on. The flow 1000 continues with receiving an image 1020. The image 1020 can be received from a camera, a sensor, and so on. As previously discussed, the camera or cameras can include a webcam, where a webcam can include a video camera, a still camera, a thermal imager, a CCD device, a phone camera, a three-dimensional camera, a depth camera, a light field camera, multiple webcams used to show different views of a person, or any other type of image capture apparatus that can allow captured data to be used in an electronic system. The image that is received can be manipulated in order to improve the processing of the image. For example, the image can be cropped, scaled, stretched, rotated, flipped, etc., in order to obtain a resulting image that can be analyzed more efficiently. Multiple versions of the same image can be analyzed. In some cases, the manipulated image and a flipped or mirrored version of the manipulated image can be analyzed alone and/or in combination to improve analysis. The flow 1000 continues with generating histograms 1030 for the training images and the one or more versions of the received image. The histograms can be based on a HoG or another histogram. As described in previous paragraphs, the HoG can include feature descriptors and can be computed for one or more regions of interest in the training images and the one or more received images. The regions of interest in the images can be located using facial landmark points, where the facial landmark points can include outer edges of nostrils, outer edges of the mouth, outer edges of eyes, etc. A HoG for a given region of interest can count occurrences of gradient orientation within a given section of a frame from a video.

The flow 1000 continues with applying classifiers 1040 to the histograms. The classifiers can be used to estimate probabilities, where the probabilities can correlate with an intensity of an AU or an expression. In some embodiments, the choice of classifiers used is based on the training of a supervised learning technique to identify facial expressions. The classifiers can be used to identify into which of a set of categories a given observation can be placed. The classifiers can be used to determine a probability that a given AU or expression is present in a given image or frame of a video. In various embodiments, the one or more AUs that are present include AU01 inner brow raiser, AU12 lip corner puller, AU38 nostril dilator, and so on. In practice, the presence or absence of multiple AUs can be determined. The flow 1000 continues with computing a frame score 1050. The score computed for an image, where the image can be a frame from a video, can be used to determine the presence of a facial expression in the image or video frame. The score can be based on one or more versions of the image 1020 or a manipulated image. The score can be based on a comparison of the manipulated image to a flipped or mirrored version of the manipulated image. The score can be used to predict a likelihood that one or more facial expressions are present in the image. The likelihood can be based on computing a difference between the outputs of a classifier used on the manipulated image and on the flipped or mirrored image, for example. The classifier can be used to identify symmetrical facial expressions (e.g. smile), asymmetrical facial expressions (e.g. outer brow raiser), and so on.

The flow 1000 continues with plotting results 1060. The results that are plotted can include one or more scores for one or more frames computed over a given time t. For example, the plotted results can include classifier probability results from analysis of HoGs for a sequence of images and video frames. The plotted results can be matched with a template 1062. The template can be temporal and can be represented by a centered box function or another function. A best fit with one or more templates can be found by computing a minimum error. Other best-fit techniques can include polynomial curve fitting, geometric curve fitting, and so on. The flow 1000 continues with applying a label 1070. The label can be used to indicate that a particular facial expression has been detected in the one or more images or video frames which constitute the image 1020 that was received. The label can be used to indicate that any of a range of facial expressions has been detected, including a smile, an asymmetric smile, a frown, and so on. Various steps in the flow 1000 may be changed in order, repeated, omitted, or the like without departing from the disclosed concepts. Various embodiments of the flow 1000 can be included in a computer program product embodied in a non-transitory computer readable medium that includes code executable by one or more processors. Various embodiments of the flow 1000, or portions thereof, can be included on a semiconductor chip and implemented in special purpose logic, programmable logic, and so on. Various embodiments of flow 1000, or portions thereof, can be used in providing instructions to and manipulating robots.

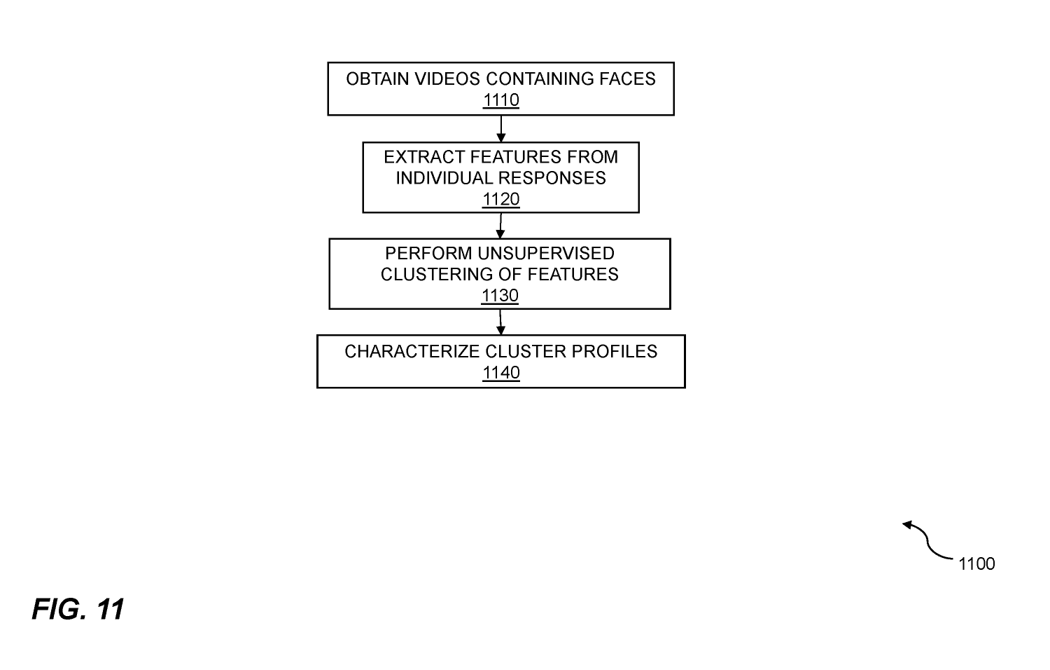

FIG. 11 is a flow diagram for the large-scale clustering of facial events. The large-scale clustering of facial events can be performed for data collected from images of an individual. The collected images can be analyzed for mental states and/or facial expressions. The mental states and/or facial expressions can be used to provide instructions to and manipulate robots. A plurality of images can be received of an individual viewing an electronic display. A face can be identified in an image, based on the use of classifiers. The plurality of images can be evaluated to determine the mental states and/or facial expressions of the individual. The clustering and evaluation of facial events can be augmented using a mobile device, a server, semiconductor based logic, and so on. As discussed above, collection of facial video data from one or more people can include a web-based framework. The web-based framework can be used to collect facial video data from large numbers of people located over a wide geographic area. The web-based framework can include an opt-in feature that allows people to agree to facial data collection. The web-based framework can be used to render and display data to one or more people and can collect data from the one or more people. For example, the facial data collection can be based on showing a video media presentation to one or more viewers through a website. The web-based framework can be used to display the video media presentation or event and to collect videos from multiple viewers who are online. That is, the collection of videos can be crowdsourced from those viewers who elected to opt-in to the video data collection. The video event can be a commercial, a political ad, an educational segment, and so on.

The flow 1100 begins with obtaining videos containing faces 1110. The videos can be obtained using one or more cameras, where the cameras can include a webcam coupled to one or more devices employed by the one or more people using the web-based framework. The flow 1100 continues with extracting features from the individual responses 1120. The individual responses can include videos containing faces observed by the one or more webcams. The features that are extracted can include facial features such as an eyebrow, a nostril, an eye edge, a mouth edge, and so on. The feature extraction can be based on facial coding classifiers, where the facial coding classifiers output a probability that a specified facial action has been detected in a given video frame. The flow 1100 continues with performing unsupervised clustering of features 1130. The unsupervised clustering can be based on an event. The unsupervised clustering can be based on a K-Means, where the K of the K-Means can be computed using a Bayesian Information Criterion (BICk), for example, to determine the smallest value of K that meets system requirements. Any other criterion for K can be used. The K-Means clustering technique can be used to group one or more events into various respective categories.

The flow 1100 continues with characterizing cluster profiles 1140. The profiles can include a variety of facial expressions such as smiles, asymmetric smiles, eyebrow raisers, eyebrow lowerers, etc. The profiles can be related to a given event. For example, a humorous video can be displayed in the web-based framework and the video data of people who have opted-in can be collected. The characterization of the collected and analyzed video can depend in part on the number of smiles that occurred at various points throughout the humorous video. The number of smiles resulting from people viewing a humorous video can be compared to various demographic groups, where the groups can be formed based on geographic location, age, ethnicity, gender, and so on. Similarly, the characterization can be performed on collected and analyzed videos of people viewing a news presentation. The characterized cluster profiles can be further analyzed based on demographic data. Various steps in the flow 1100 may be changed in order, repeated, omitted, or the like without departing from the disclosed concepts. Various embodiments of the flow 1100 can be included in a computer program product embodied in a non-transitory computer readable medium that includes code executable by one or more processors. Various embodiments of the flow 1100, or portions thereof, can be included on a semiconductor chip and implemented in special purpose logic, programmable logic, and so on. Various embodiments of flow 1100, or portions thereof, can be used in providing instructions to and manipulating robots.

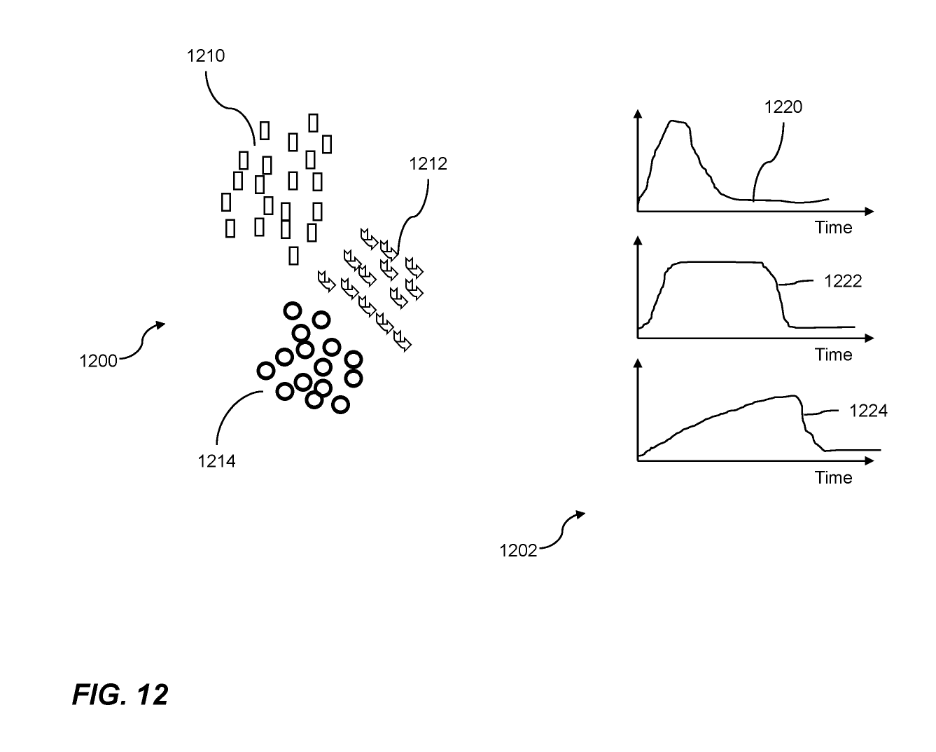

FIG. 12 shows unsupervised clustering of features and characterizations of cluster profiles. The clustering can be accomplished as part of a deep learning effort. The clustering of features and characterizations of cluster profiles can be performed for images collected of an individual. The collected images can be analyzed for mental states and/or facial expressions. The mental states and/or facial expressions can be used to provide instructions to robots and to manipulate robots. A plurality of images can be received of an individual viewing an electronic display. A face can be identified in an image, based on the use of classifiers. The plurality of images can be evaluated to determine mental states and/or facial expressions of the individual. Features including samples of facial data can be clustered using unsupervised clustering. Various clusters can be formed, which include similar groupings of facial data observations. The example 1200 shows three clusters: clusters 1210, 1212, and 1214. The clusters can be based on video collected from people who have opted-in to video collection. When the data collected is captured using a web-based framework, the data collection can be performed on a grand scale, including hundreds, thousands, or even more participants who can be located locally and/or across a wide geographic area. Unsupervised clustering is a technique that can be used to process the large amounts of captured facial data and to identify groupings of similar observations. The unsupervised clustering can also be used to characterize the groups of similar observations. The characterizations can include identifying behaviors of the participants. The characterizations can be based on identifying facial expressions and facial action units of the participants. Some behaviors and facial expressions can include faster or slower onsets, faster or slower offsets, longer or shorter durations, etc. The onsets, offsets, and durations can all correlate to time. The data clustering that results from the unsupervised clustering can support data labeling. The labeling can include FACS coding. The clusters can be partially or totally based on a facial expression resulting from participants viewing a video presentation, where the video presentation can be an advertisement, a political message, educational material, a public service announcement, and so on. The clusters can be correlated with demographic information, where the demographic information can include educational level, geographic location, age, gender, income level, and so on.

The cluster profiles 1202 can be generated based on the clusters that can be formed from unsupervised clustering, with time shown on the x-axis and intensity or frequency shown on the y-axis. The cluster profiles can be based on captured facial data including facial expressions. The cluster profile 1220 can be based on the cluster 1210, the cluster profile 1222 can be based on the cluster 1212, and the cluster profile 1224 can be based on the cluster 1214. The cluster profiles 1220, 1222, and 1224 can be based on smiles, smirks, frowns, or any other facial expression. The emotional states of the people who have opted-in to video collection can be inferred by analyzing the clustered facial expression data. The cluster profiles can be plotted with respect to time and can show a rate of onset, a duration, and an offset (rate of decay). Other time-related factors can be included in the cluster profiles. The cluster profiles can be correlated with demographic information, as described above. The cluster profiles can be used in providing instructions to and manipulating robots.

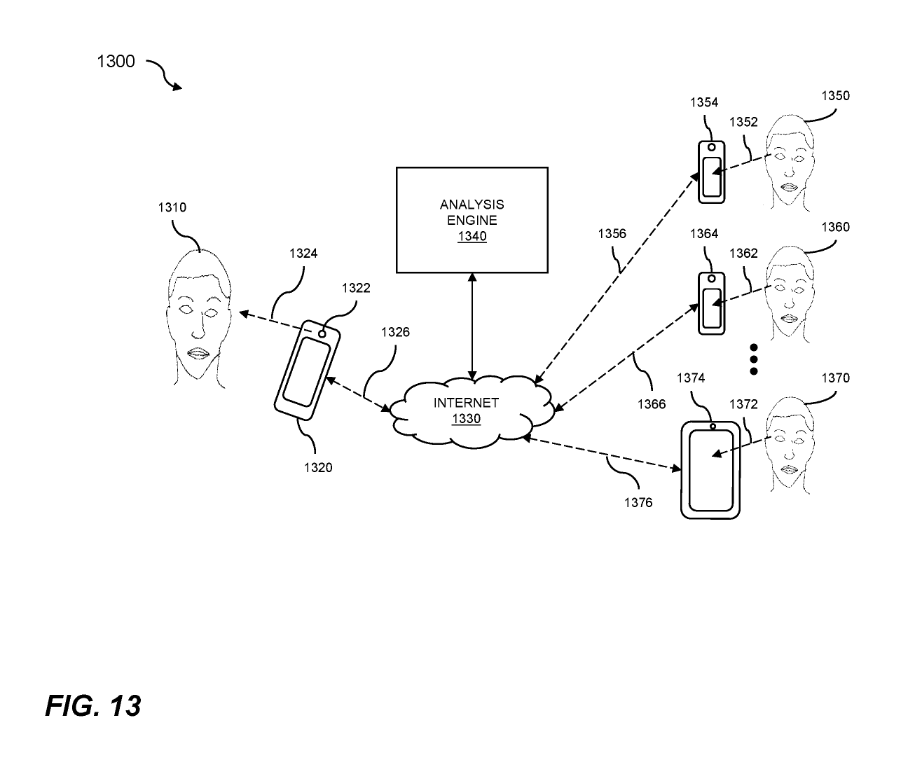

FIG. 13 illustrates an example of live streaming. The live streaming can be of a person, or a group of people, controlling a robot through facial expressions, or it can be of the robot that is being controlled. In some embodiments, both the robot and the person or people are both shown during the livestreaming. The live streaming can include social video. Such streaming can include mental state event signature analysis. Live-streaming video is an example of one-to-many social media, where video is sent over the Internet from one person to a plurality of people using a social media app and/or platform. Live-streaming is one of numerous popular techniques used by people who want to disseminate ideas, send information, provide entertainment, share experiences, and so on. Some of the live streams can be scheduled, such as events including robots, webcasts, online classes, sporting events, news, computer gaming, or videoconferences, while others can be impromptu streams that are broadcast as and when needed or desirable. Examples of impromptu live-stream videos can range from individuals simply wanting to share experiences with their social media followers, to coverage of breaking news, emergencies, or natural disasters. This latter coverage can be known as mobile journalism, or “mo jo”, and is becoming increasingly commonplace. “Reporters” can use networked, portable electronic devices to provide mobile journalism content to a plurality of social media followers. Such reporters can be quickly and inexpensively deployed as the need or desire arises. Another example of live-stream videos can include one or more viewers viewing and controlling a robot. The sender or “reporter” may choose to share the experience of controlling the robot with their social media followers. The report can allow the social media followers to participate in the control of the robot, to make comments regarding the control of the robot, and so on.

Several live-streaming social media apps and platforms can be used for transmitting video. One such video social media app is Meerkat™ that can link with a user's Twitter™ account. Meerkat™ enables a user to stream video using a handheld, networked, electronic device coupled to video capabilities. Viewers of the live stream can comment on the stream using tweets that can be seen by and responded to by the broadcaster. Another popular app is Periscope™ that can transmit a live recording from one user to that user's Periscope™ and other followers. The Periscope™ app can be executed on a mobile device. The user's Periscope™ followers can receive an alert whenever that user begins a video transmission. Another live-stream video platform is Twitch™, which can be used for video streaming of video gaming and broadcasts of various competitions and events.

The example 1300 shows a user 1310 broadcasting a video live stream to one or more people 1350, 1360, 1370, and so on. A portable, network-enabled electronic device 1320 can be coupled to a camera 1322 that is facing the user 1310. In other embodiments, the camera could face away from the user. The portable electronic device 1320 can be a smartphone, a PDA, a tablet, a laptop computer, and so on. The camera 1322 coupled to the device 1320 can have a line-of-sight view 1324 to the user 1310 and can capture video of the user 1310. The captured video can be sent to an analysis engine 1340 using a network link 1326 to the Internet 1330. The network link can be a wireless link, a wired link, and so on. The recommendation engine 1340 can recommend to the user 1310 an app and/or platform that can be supported by the server and can be used to provide a video live stream to one or more followers of the user 1310. The example 1300 shows three people, person 1350, person 1360, and person 1370, as followers of user 1310. Each follower has a line-of-sight view to a video screen on a portable, networked electronic device. In other embodiments, one or more followers are following the user 1310 using any other networked electronic device including a computer. In the example 1300, the person 1350 has a line-of-sight view 1352 to the video screen of a device 1354, the person 1360 has a line-of-sight view 1362 to the video screen of a device 1364, and the person 1370 has a line-of-sight view 1372 to the video screen of a device 1374. The portable electronic devices 1354, 1364, and 1374 each can be a smartphone, a PDA, a tablet, and so on. Each portable device can receive the video stream being broadcast by the user 1310 through the Internet 1330 using the app and/or platform that can be recommended by the recommendation engine 1340. The device 1354 can receive a video stream using a network link 1356, the device 1364 can receive a video stream using a network link 1366, the device 1374 can receive a video stream using a network link 1376, and so on. The network link can be a wireless link, and wired link, and so on. Depending on the app and/or platform that can be recommended by the recommendation engine 1340, one or more followers, for example, the followers 1350, 1360, 1370, and so on, can reply to, comment on, and otherwise provide feedback to the user 1310 using their devices 1354, 1364, and 1374 respectively. Similarly, livestreaming of controlled robots and the respective facial expressions can be shown.

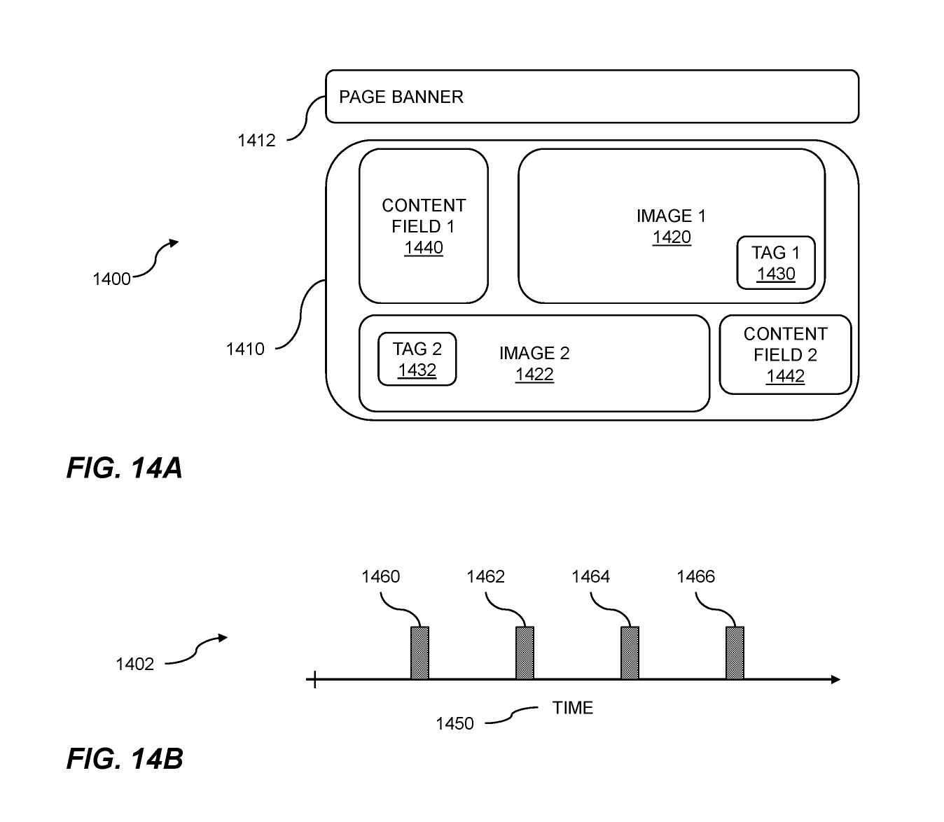

FIG. 14A shows example tags embedded in a webpage. As these tags are encountered, facial expression data can be collected and used to control a robot. A webpage 1400 can include a page body 1410, a page banner 1412, and so on. The page body can include one or more objects, where the objects can include text, images, videos, audio, etc. The example page body 1410 shown includes a first image, image 1 1420; a second image, image 2 1422; a first content field, content field 1 1440; and a second content field, content field 2 1442. In practice, the page body 1410 can contain any number of images and content fields and can include one or more videos, one or more audio presentations, and so on. The page body can include embedded tags, such as tag 1 1430 and tag 2 1432. In the example shown, tag 1 1430 is embedded in image 1 1420, and tag 2 1432 is embedded in image 2 1422. In embodiments, any number of tags are imbedded. Tags can also be imbedded in content fields, in videos, in audio presentations, etc. When a user mouses over a tag or clicks on an object associated with a tag, the tag can be invoked. For example, when the user mouses over tag 1 1430, tag 1 1430 can then be invoked. Invoking tag 1 1430 can include enabling a camera coupled to a user's device and capturing one or more images of the user as the user views a robot, a media presentation (or digital experience), and so on. In a similar manner, when the user mouses over tag 2 1432, tag 2 1432 can be invoked. Invoking tag 2 1432 can also include enabling the camera and capturing images of the user. In other embodiments, other actions are taken based on invocation of the one or more tags. For example, invoking an embedded tag can generate an instruction that can be used to control one or more robots. In another example, invoking an embedded tag can initiate an analysis technique, post to social media, award the user a coupon or another prize, initiate mental state analysis, perform emotion analysis, and so on. These latter actions can also be associated with control of one or more robots.

FIG. 14B shows an example of invoking a tag to collect images. As stated above, a media presentation can be a video, a webpage, and so on. A robot can be controlled generally throughout time. Alternatively, in some embodiments, the robot is controlled by facial expression analysis during the times where the tags are invoked. A video 1402 can include one or more embedded tags, such as a tag 1460, another tag 1462, a third tag 1464, a fourth tag 1466, and so on. In practice, any number of tags can be included in the media presentation, a digital presentation, and so on. The one or more tags can be invoked during the media presentation. The collection of the invoked tags can occur over time as represented by a timeline 1450. When a tag is encountered in the media presentation, the tag can be invoked. For example, when the tag 1460 is encountered, invoking the tag can enable a camera coupled to a user device and can capture one or more images of the user viewing the media presentation. Invoking a tag can depend on opt-in by the user. For example, if a user has agreed to participate in a study by indicating an opt-in, then the camera coupled to the user's device can be enabled and one or more images of the user can be captured. If the user has not agreed to participate in the study and has not indicated an opt-in, then invoking the tag 1460 does not enable the camera nor capture images of the user during the media presentation. The user can indicate an opt-in for certain types of participation, where opting-in can be dependent on specific content in the media presentation, types of robots and techniques for controlling one or more robots, and so on. For example, the user could opt-in to participation in a study of controlling an individual robot and not opt-in for a particular robot type. In this case, tags that are related to controlling a robot and that enable the camera and image capture when invoked would be embedded in the media presentation. However, tags imbedded in the media presentations that are related to or media presentations would not enable the camera when invoked. Various other situations of tag invocation are possible.

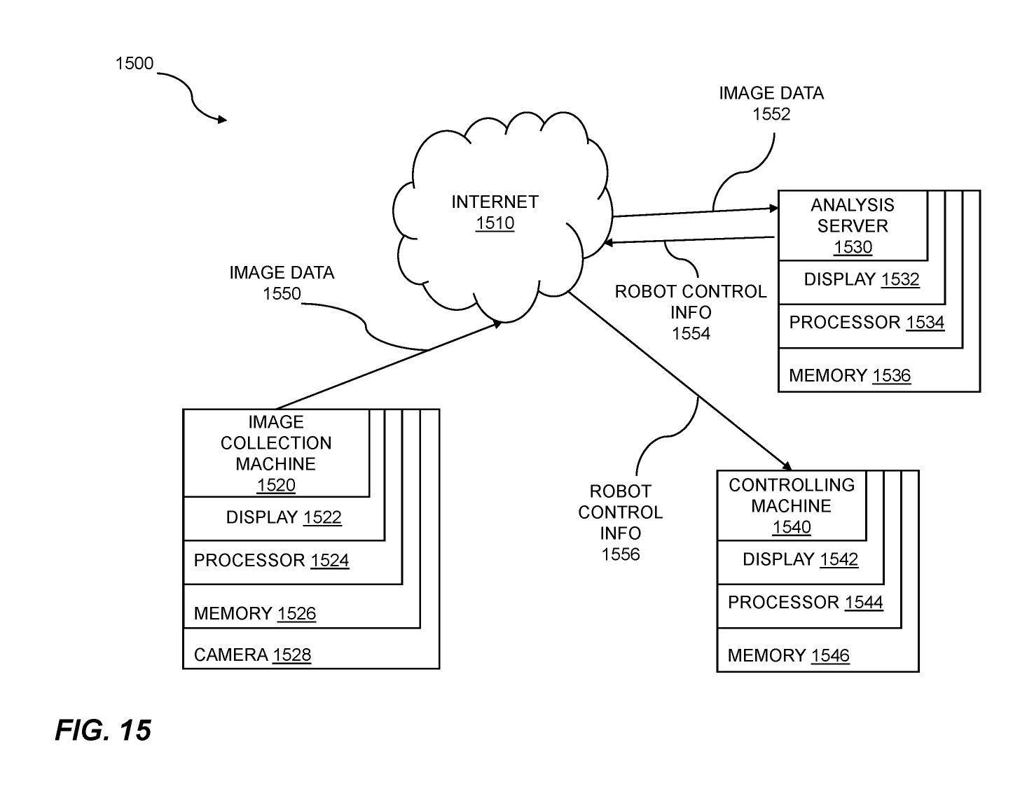

FIG. 15 is a system for image analysis and robotic control. An example system 1500 is shown for image collection, analysis, and control of a robot. The system 1500 can provide a computer-implemented method for image analysis comprising: obtaining a series of images of an individual; analyzing an image from the series of images to capture mental state data, wherein the mental state data includes facial data for the individual; inferring a mental state based on the mental state data which was captured; and providing an instruction to a robot based on the mental state that was inferred.

The system 1500 can include one or more image collection machines 1520 linked to an analysis server 1530 and a robot controlling machine 1540 via the Internet 1510 or another computer network. The network can be wired or wireless. Image data 1550 can be transferred to the analysis server 1530 through the Internet 1510, for example. The example image collection machine 1520 shown comprises one or more processors 1524 coupled to a memory 1526 which can store and retrieve instructions, a display 1522, and a camera 1528. The camera 1528 can include a webcam, a video camera, a still camera, a thermal imager, a CCD device, a phone camera, a three-dimensional camera, a depth camera, a light field camera, multiple webcams used to show different views of a person, or any other type of image capture technique that can allow captured data to be used in an electronic system. The memory 1526 can be used for storing instructions, image data on a plurality of people, one or more classifiers, and so on. The display 1522 can be any electronic display, including but not limited to, a computer display, a laptop screen, a net-book screen, a tablet computer screen, a smartphone display, a mobile device display, a remote with a display, a television, a projector, or the like.

The analysis server 1530 can include one or more processors 1534 coupled to a memory 1536 which can store and retrieve instructions, and it can also include a display 1532. The analysis server 1530 can receive the image data 1552 and analyze the image. The analysis server 1530 can use image data received from the image data collection machine 1520 to produce robot control information data 1554. In some embodiments, the analysis server 1530 receives image data from a plurality of image data collection machines, aggregates the image data, processes the image data or the aggregated image data, and so on. In some embodiments, the analysis server 1530 captures mental state data from the image data 1552 and infers mental states from the mental state data.

The robot controlling machine 1540 can include one or more processors 1544 coupled to a memory 1546 which can store and retrieve instructions and data, and it can also include a display 1542. The controlling of one or more robots based on robot control information data 1554 can occur on the controlling machine 1540 or on a different platform from the controlling machine 1540. The controlling of the robot can occur in the robot itself. The controlling of the one or more robots can occur in the one or more robots themselves. In embodiments, the controlling based on the robot control information data occurs on the image data collection machine 1520 or on the analysis server 1530. As shown in the system 1500, the controlling machine 1540 can receive robot control information data 1556 via the Internet 1510 or another network from the image data collection machine 1520, from the analysis server 1530, or from both. The controlling machine can include a visual display or any other appropriate display format. The system 1500 can include a computer program product embodied in a non-transitory computer readable medium for analysis comprising code which causes one or more processors to perform operations of: obtaining a series of images of an individual; analyzing an image from the series of images to capture mental state data, wherein the mental state data includes facial data for the individual; inferring a mental state based on the mental state data which was captured; and providing an instruction to a robot based on the mental state that was inferred.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A processor-implemented method for robotic manipulation comprising:
obtaining a series of images of an individual;
analyzing an image from the series of images to capture mental state data, wherein the mental state data includes facial data for the individual;
inferring a mental state based on the mental state data which was captured; and
providing an instruction to a robot based on the mental state that was inferred.

2. (canceled)

3. The method of claim 1 further comprising:
identifying multiple human faces within the image from the series of images;
defining a region of interest (ROI) in the image for each identified human face;
extracting one or more histogram-of-oriented-gradients (HoG) features from each ROI; and
computing a set of facial metrics based on the one or more HoG features for each of the multiple human faces.

4. The method of claim 1 wherein the inferring of the mental state is further based on speech information from the individual.

5. The method of claim 4 wherein the speech information includes tonal information, intonation, voice cadence, voice intensity, voice prosody, or voice pitch.

6. The method of claim 4 wherein the speech information includes language information.

7. The method of claim 1 wherein the analyzing uses one or more classifiers.

8. The method of claim 1 wherein the instruction is based on valence for the individual.

9. (canceled)

10. The method of claim 1 further comprising determining context within which the robot is operating.

11. The method of claim 1 further comprising determining context for the individual.

12. The method of claim 1 wherein the series of images comprise a video.

13. (canceled)

14. The method of claim 1 wherein the analyzing includes facial expression analysis.

15. The method of claim 1 further comprising analyzing a second image from the series of images.

16. The method of claim 15 further comprising providing a second instruction to the robot based on the second image.

17. The method of claim 15 further comprising evaluating a change between the image and the second image.

18. The method of claim 17 wherein the providing the instruction is further based on the change.

19. The method of claim 17 wherein the change occurs over a time duration.

20. The method of claim 1 wherein the instructing the robot produces motion in the robot.

21. The method of claim 1 wherein the instructing the robot causes the robot to change locations.

22. The method of claim 21 wherein the instructing the robot is based on a distance from the robot to the individual.

23-24. (canceled)

25. The method of claim 1 wherein the instructing the robot produces an image change on a display on the robot.

26. The method of claim 1 wherein the robot includes a social robot.

27. The method of claim 1 wherein the instructing the robot results in the robot providing information to the individual.

28. The method of claim 1 wherein the instructing the robot results in the robot providing information to a third party.

29. (canceled)

30. The method of claim 1 wherein the analyzing is accomplished using an SDK.

31. (canceled)

32. The method of claim 1 herein the analyzing includes detection of one or more of sadness, stress, happiness, anger, frustration, confusion, disappointment, hesitation, cognitive overload, focusing, engagement, attention, boredom, exploration, confidence, trust, delight, disgust, skepticism, doubt, satisfaction, excitement, laughter, calmness, curiosity, humor, sadness, poignancy, or mirth.

33. The method of claim 32 wherein the providing an instruction is based on the detection.

34. A computer program product embodied in a non-transitory computer readable medium for analysis comprising code which causes one or more processors to perform operations of:
obtaining a series of images of an individual;
analyzing an image from the series of images to capture mental state data, wherein the mental state data includes facial data for the individual;
inferring a mental state based on the mental state data which was captured; and
providing an instruction to a robot based on the mental state that was inferred.

35. A computer system for analysis comprising:
a memory which stores instructions;
one or more processors attached to the memory wherein the one or more processors, when executing the instructions which are stored, are configured to:
obtain a series of images of an individual;
analyze an image from the series of images to capture mental state data, wherein the mental state data includes facial data for the individual;
infer a mental state based on the mental state data which was captured; and
provide an instruction to a robot based on the mental state that was inferred.
